(19) United States
(12) Patent Application Publication
(10) Pub. No.: US 2005/0066343 A1
(43) Pub. Date: Mar. 24, 2005

(54) Recording medium transporting apparatus and disc changer apparatus

(76) Inventors: Hajime Mizuno, Chiba (JP); Takeshi Sano, Chiba (JP); Kenichi Hirano, Tochighi (JP); Hiroyuki Sato, Kanagawa (JP); Shinji Ito, Tokyo (JP)

Correspondence Address: William E. Vaughan;Bell, Boyd & Lloyd LLC, P.O. Box 1135, Chicago, IL, 60690, US

(21) Appl. No.: 10/923,560

(22) Filed: Aug. 20, 2004

(30) Foreign Application Priority Data
Sep. 5, 2003 (JP) P2003-314822
Sep. 5, 2003 (JP) P2003-314824
Apr. 30, 2004 (JP) P2004-136921

(51) Int. Cl. G11B 21/08; G11B 7/085; G11B 17/04

(52) U.S. Cl. 720/619; 369/30.86

(57) ABSTRACT

A recording medium transporting apparatus and a disc changer apparatus in which a number of recording mediums can be exchanged at a time and in which the operation of exchanging the recording mediums may be facilitated are provided. The recording medium transporting apparatus or the disc changer apparatus includes a main body unit of the apparatus, a stocker for housing a recording medium, and a stocker transporting mechanism for transporting the stocker across the inner side and the outside of the main body unit of the apparatus, in a direction parallel to the major surface of the recording medium. The stocker is set upright outside the main body unit of the apparatus to permit the exchange of the recording medium by gripping the outer rim part of the recording medium.

### CROSS REFERENCES TO RELATED APPLICATION

This application claims priority to Japanese Patent Application Nos. P2003-314822, filed on Sep. 5, 2003; P2003-314824, filed on Sep. 5, 2003; and P2004-136921, filed on Apr. 30, 2004, the disclosures of which are incorporated by reference herein.

### BACKGROUND OF THE INVENTION

The present invention relates to a recording medium transporting apparatus, including a stocker for housing a plural number of recording mediums, in a stacked state, and to a disc changer apparatus, adapted for recording and/or reproducing signals for a selected one of the disc-shaped recording mediums, housed in the stocker.

There has so far been known a disc changer apparatus housing a plural number of disc-shaped recording mediums, and which is adapted for recording or reproducing signals for a selected one of these disc-shaped recording mediums. See, Japanese Laid-Open Patent Publication H5-20765.

Among the disc changer apparatus, there is such a one having plural disc trays, these disc trays being transported into and out of the main body unit of the apparatus, with each disc tray holding an optical disc thereon. If, with this disc changer apparatus, a desired address is selected, in exchanging the optical disc, the disc tray of the selected address is moved to outside the main body unit of the apparatus. In this state, the optical disc is inserted into or taken out from the disc tray. Moreover, if, with this disc changer apparatus, the optical disc of the desired address is to be reproduced, the optical disc is moved, along with the disc tray, to the reproducing unit in the main body unit of the apparatus.

With this disc changer apparatus, in which the selected disc tray has to be individually moved to outside the main body unit of the apparatus for exchanging the optical disc, the disc exchange operation is extremely time-consuming. Moreover, since the plural optical discs cannot be exchanged at a time, the optical disc exchange operation means a highly laborious operation.

In a certain disc changer apparatus, a stocker, also called a magazine, carrying a plural number of disc housing components, each housing an optical disc, is loaded on the main body unit of the apparatus. With this disc changer apparatus, a stocker is taken out manually from the main body unit of the apparatus, and the optical disc is introduced into or taken out from the disc housing component of the stocker. Moreover, with this disc changer apparatus, the optical disc is transported by a disc transporting mechanism up to the reproducing unit in the main body unit of the apparatus in reproducing the optical disc of the desired address.

However, with this disc changer apparatus, the stocker again has to be taken out manually from the main body unit of the apparatus, in exchanging the optical disc, and hence an onerous operation has to be performed in exchanging the optical discs.

### SUMMARY OF THE INVENTION

The present invention provides in an embodiment a recording medium transporting apparatus and a disc changer apparatus, according to which plural recording mediums can be exchanged at a time and in which the recording medium exchanging operation may be facilitated.

In an embodiment, the present invention provides a recording medium transporting apparatus comprising a main body unit, a stocker for housing a plurality of recording mediums therein, and a stocker transporting mechanism for rotationally supporting the stocker and for transporting the stocker across an inner part and an outer side of the main body unit.

In an embodiment, the present invention provides a recording medium transporting apparatus comprising a main body unit, a stocker having a plurality of disc housing components, each for housing a recording medium, the disc housing components being stacked together, and a stocker transporting mechanism for transporting the stocker across an inner part and an outer side of the main body unit in a direction parallel to each major surface of the recording medium.

In yet another embodiment, the present invention provides a disc changer apparatus including a stocker including a plurality of disc housing components for housing a plurality of disc-shaped recording mediums in a stacked state, a main body unit including a disc drive unit for recording and/or reproducing signals for a selected one of the disc-shaped recording mediums housed in the stocker, and a stocker transporting mechanism for transporting the stocker between a pullout position in which the stocker is pulled out from the main body unit and a housed position in which the stocker is pulled into and housed within the main body unit. When the stocker has been transported to the pullout position, the stocker transporting mechanism rotates the stocker so that the disc insertion/ejection opening of the disc housing component is oriented in a direction different from the direction when the stocker is in the housing position.

With the recording medium transporting mechanism of the present invention, in which the stocker having the plural recording mediums housed therein is pulled out from the main body unit of the apparatus by the stocker transporting mechanism, the recording medium exchange operation may be completed in a shorter time.

Moreover, with the recording medium transporting apparatus of the present invention, in which, when the stocker has been transported to the pullout position by the stocker transporting mechanism, the stocker transporting mechanism rotates the stocker so that the disc insertion/ ejection opening of the disc housing component is oriented in a direction different from the direction when the stocker is in the housing position, the operation of exchanging the disc-shaped recording medium may be completed in a shorter time readily in dependence upon the orientation of stocker rotation.

Additional features and advantages of the present invention are described in, and will be apparent from, the following Detailed Description of the Invention and the figures.

### BRIEF DESCRIPTION OF THE FIGURES

FIG. 1 is a perspective view of a disc transporting apparatus embodying the present invention.

FIG. 2 illustrates the structure of the disc transporting apparatus.

FIG. 3 is an exploded perspective view of a stocker transporting mechanism used for the disc transporting apparatus, looking from the side of the stocker transporting mechanism provided with a first driving unit.

FIG. 4 is a perspective view of the stocker transporting mechanism, looking from the opposite side of the stocker transporting mechanism provided with a second driving unit.

FIG. 5 is a perspective view for illustrating a stocker rotating mechanism.

FIG. 6 is a side view for illustrating the state in which a stocker is housed in a main body unit.

FIG. 7 is a side view for illustrating the state in which a stocker is being transported to outside the main body unit.

FIG. 8 is a side view for illustrating the state in which the stocker has been transported to outside the main body unit and an optical disc is ready to be exchanged.

FIG. 9 illustrates another example of the stocker.

FIG. 10 is a plan view showing a disc changer apparatus embodying the present invention.

FIG. 11 is a side view showing the state in which a stocker of the disc changer apparatus is in the housed position.

FIG. 12 is a side view showing the state in which a stocker of the disc changer apparatus is in the pullout position.

FIG. 13 is a front view showing the state in which a stocker of the disc changer apparatus is in the housed position.

FIG. 14 is a front view showing the state in which a stocker of the disc changer apparatus is in the pullout position.

FIG. 15 is a side view showing the state in which a stocker of a second driving unit forming the stocker transport mechanism is in a housed position.

FIG. 16 is a side view showing the state in which the stocker of the second driving unit forming the stocker transport mechanism has been rotated in a direction indicated by an arrow F.

FIG. 17 is a side view showing the state in which a stocker of a second driving unit forming the stocker transport mechanism is in a pullout position.

FIG. 18 is a perspective view showing a fifth transmission gear.

FIG. 19(a) is a perspective view of a sixth transmission gear, looking from a side.

FIG. 19(b) is a perspective view of a sixth transmission gear, looking from the opposite side.

FIG. 20 is a perspective view showing a seventh transmission gear.

FIG. 21 is a perspective view showing an eighth transmission gear, a rotational gear and a cover member.

FIG. 22 illustrates rotation of the stocker and is a partial see-through side view showing the state in which the stocker is in the housed position.

FIG. 23 illustrates rotation of the stocker and is a partial see-through side view showing the state in which the stocker is in the pullout position.

FIG. 24 illustrates sliding of the stocker and is a partial see-through side view showing the state in which the stocker is in the housed position.

FIG. 25 illustrates sliding of the stocker and is a partial see-through side view showing the state in which the stocker is in the pullout position.

FIG. 26 is a perspective view showing essential parts of a rotation lock mechanism.

FIG. 27 is a perspective view showing essential parts of a thrusting mechanism.

FIG. 28 is a front view of a disc housing components.

FIG. 29 is a back-side view of the disc housing components.

FIG. 30 is a partial see-through plan view showing the state in which the optical disc has been housed in the disc housing components.

FIG. 31 is a partial see-through plan view showing the state in which the optical disc is being pushed out from the disc housing components.

FIG. 32 is a partial see-through plan view showing the state in which the optical disc has been expelled from the disc housing components.

FIG. 33 is a side view showing essential parts of the main body unit and more particularly showing a disc presence/absence detection mechanism and a disc ejection mechanism.

FIG. 34, illustrating the operation of the disc presence/absence detection mechanism, is a plan view showing the state of disc presence.

FIG. 35, illustrating the operation of the disc presence/absence detection mechanism, is a plan view showing the state of disc absence.

FIG. 36 is a perspective view of a disc driving unit, looking from above.

FIG. 37 is a perspective view of a disc driving unit, looking from below.

FIG. 38 is a plan view showing a base.

FIG. 39, illustrating the operation of an 8 cm disc transporting mechanism, is a plan view showing essential parts thereof with the optical disc located towards the stocker.

FIG. 40, illustrating the operation of an 8 cm disc transporting mechanism, is a plan view showing essential parts thereof with the optical disc shifted closer to the disc drive unit side than in FIG. 39.

FIG. 41, illustrating the operation of an 8 cm disc transporting mechanism, is a plan view showing essential parts thereof with the optical disc shifted closer to the disc drive unit side than in FIG. 40.

FIG. 42, illustrating the operation of an 8 cm disc transporting mechanism, is a plan view showing essential parts thereof with the optical disc shifted closer to the disc drive unit side than in FIG. 41.

FIG. 43, illustrating the operation of an 8 cm disc transporting mechanism, is a plan view showing essential parts thereof with the optical disc positioned towards the disc drive unit.

FIG. 44, illustrating the operation of the disc ejection mechanism by the motive power transmitting mechanism, is a plan view showing essential parts thereof, with a connecting gear in a first release position.

FIG. 45, illustrating the operation of the disc ejection mechanism by the motive power transmitting mechanism, is a plan view showing essential parts thereof, with the connecting gear having been moved from the first release position to a meshing position.

FIG. 46, illustrating the operation of the disc ejection mechanism by the motive power transmitting mechanism, is a plan view showing essential parts thereof, with a first gear part meshing with a second gear part.

FIG. 47, illustrating the operation of the disc ejection mechanism by the motive power transmitting mechanism, is a plan view showing essential parts thereof, with a thrusting projecting thrusting a thrust projection.

FIG. 48, illustrating the operation of the disc ejection mechanism by the motive power transmitting mechanism, is a plan view showing essential parts thereof, with the connection gear having been moved from the meshing position to the second release position.

FIG. 49, illustrating the operation of the disc ejection mechanism by the motive power transmitting mechanism, is a plan view showing essential parts thereof, with the connection gear being in the second release position.

FIG. 50, illustrating the operation of the disc ejection mechanism by the motive power transmitting mechanism, is a plan view showing essential parts thereof in the unlocked state.

### DETAILED DESCRIPTION OF THE INVENTION

The present invention relates to a recording medium transporting apparatus, including a stocker for housing a plural number of recording mediums, in a stacked state, and to a disc changer apparatus, adapted for recording and/or reproducing signals for a selected one of the disc-shaped recording mediums, housed in the stocker.

Referring now to the drawings, certain preferred embodiments of a disc transport apparatus and a disc changer apparatus, according to the present invention, are explained in detail.

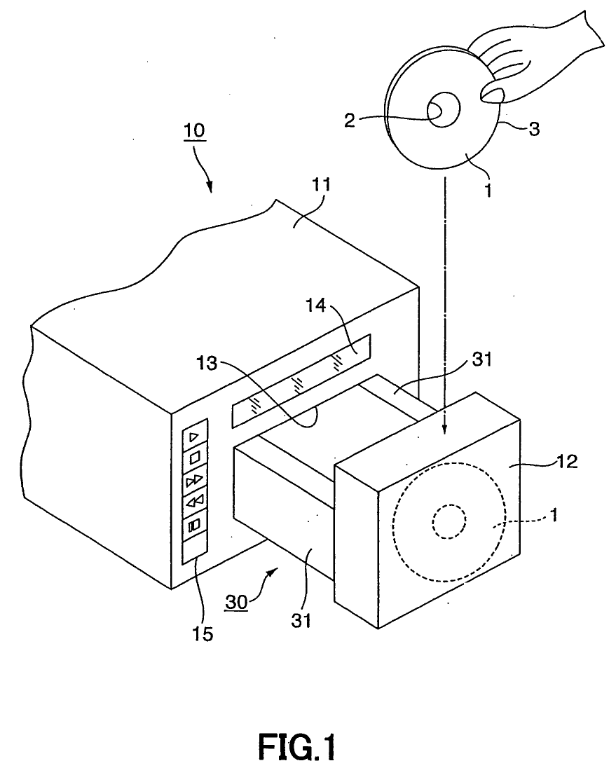

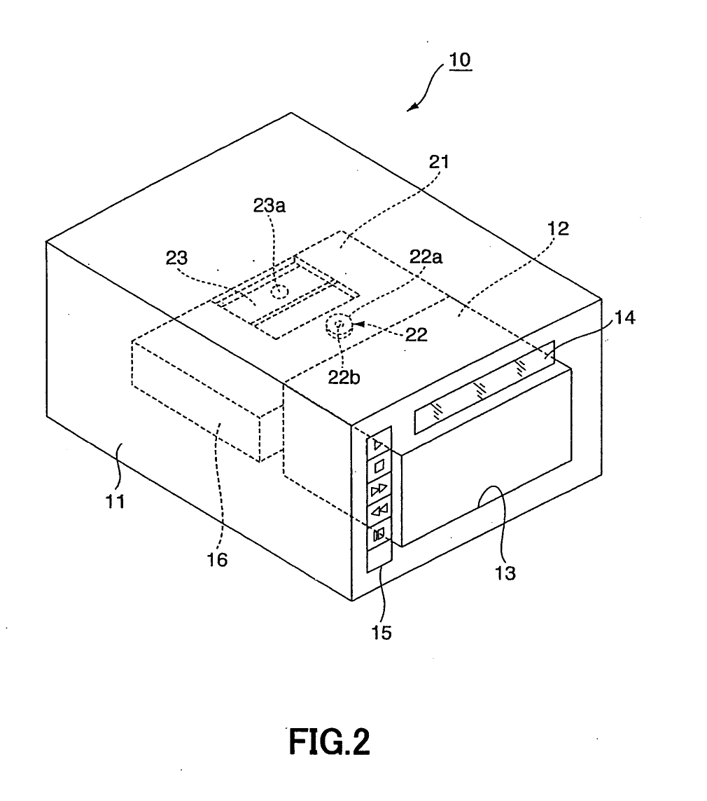

Referring to FIGS. 1 and 2, a disc transport apparatus 10, according to the present invention, includes a main body unit 11, and a stocker 12 for housing a plural number of optical discs 1, as disc-shaped recording mediums. The disc transport apparatus is applied to a disc changer apparatus for reproducing signals for a selected one of the optical discs 1 housed within the stocker 12.

The stocker 12 may be transported into and out of the main body unit 11, via a stocker insertion/ejection opening 13, formed in the front surface of the main body unit 11, and is further rotated outside the main body unit 11 so that the major surface of the disc 1 is set from the horizontal position to the upstanding position. The user may, in this state, grip the outer rim of the optical disc 1 to exchange the disc. The stocker 12 includes a plural number of disc housing components for housing the optical disc 1, although the disc housing components are not shown. In these disc housing components, the respective optical discs are housed so that major surfaces thereof run substantially parallel to one another.

The front surface of the main body unit 11, provided with the stocker insertion/ejection opening 13, is an operating surface for the disc transport apparatus, on which there is formed an indicating unit 14, formed by e.g. LCD (liquid crystal display) or LEDs (light emitting diodes). On the indicating unit 14, there are indicated operating states of the apparatus, such as address or track numbers of the optical disc 1 being reproduced, or the reproducing time. On the operating surface of the main body unit 11, there is provided an operating unit 15 for carrying out various functions provided to the apparatus. The operating unit 15 is made up e.g. by a replay start button, a replay stop button, a pause button or track jump button, which may all be pushbuttons.

Within the main body unit 11, there is provided a disc drive unit (reproducing unit) in juxtaposition to the stocker 12 accommodated therein. When an optical disc 1 of a desired address is to be reproduced, the optical disc 1 is transported from the stocker 12 within the main body unit 11 up to the reproducing unit 16.

The reproducing unit 16 includes a base 21, on which there are provided a disc rotating driving unit 22 for rotationally driving the optical disc 1, and an optical pickup 23 for illuminating a light beam on the optical disc for detecting a return light beam reflected back from the optical disc.

The disc rotating driving unit 22 includes a disc table 22a, mounted as one to a spindle of a spindle motor mounted to the back surface of the base 21. The disc table 22a includes a centering part 22b engaged in a center opening 2 of the optical disc 1. The disc table 22a has the centering part 22b engaged in the center opening 2 of the optical disc 1, and clamps the rim part of the center opening 2 of the optical disc 1 by a clamping plate, not shown, to cause rotation of the optical disc 1 at e.g. a constant linear velocity.

The optical pickup 23 for radiating a light beam on the optical disc, run in rotation by the disc rotating driving unit 22, includes a semiconductor laser, as a light source, an objective lens 23a for condensing the light beam, radiated from the semiconductor laser, and a photodetector for detecting the return light beam reflected back from the optical disc 1. The light beam, radiated from the semiconductor laser, is condensed by the objective lens 23a, and illuminated on the signal recording surface of the optical disc. The return light beam, reflected back from a reflective film of the disc, is detected by the photodetector. On detection of the return light beam, reflected back from the optical disc 1, the optical pickup 23, photo-electrically transduces the light into electrical signals, which are then output.

The objective lens 23a is carried by an objective lens driving unit for displacing the objective lens in a direction along the optical axis of the light beam and in a direction perpendicular to the recording track of the optical disc 1, in a manner not shown in detail. The objective lens driving unit displaces the objective lens 23a in a direction along the optical axis of the light beam, based on focusing error signals, generated on the basis of the electrical signals, output by the photodetector, so that the focusing error will be driven to zero. The objective lens driving unit also displaces the objective lens 23a in a direction perpendicular to the recording tracks of the optical disc 1, based on tracking error signals, generated on the basis of the electrical signals, output by the photodetector, so that the tracking error will be driven to zero.

As described above, the insertion/ejection opening 13, stocker 12 and the reproducing unit 16 are provided to the main body unit 11, in this order, looking from the front side towards the back side. The optical disc 1 is transported by a stocker transport mechanism 30 between the insertion/ejection opening 13 and the stocker 12.

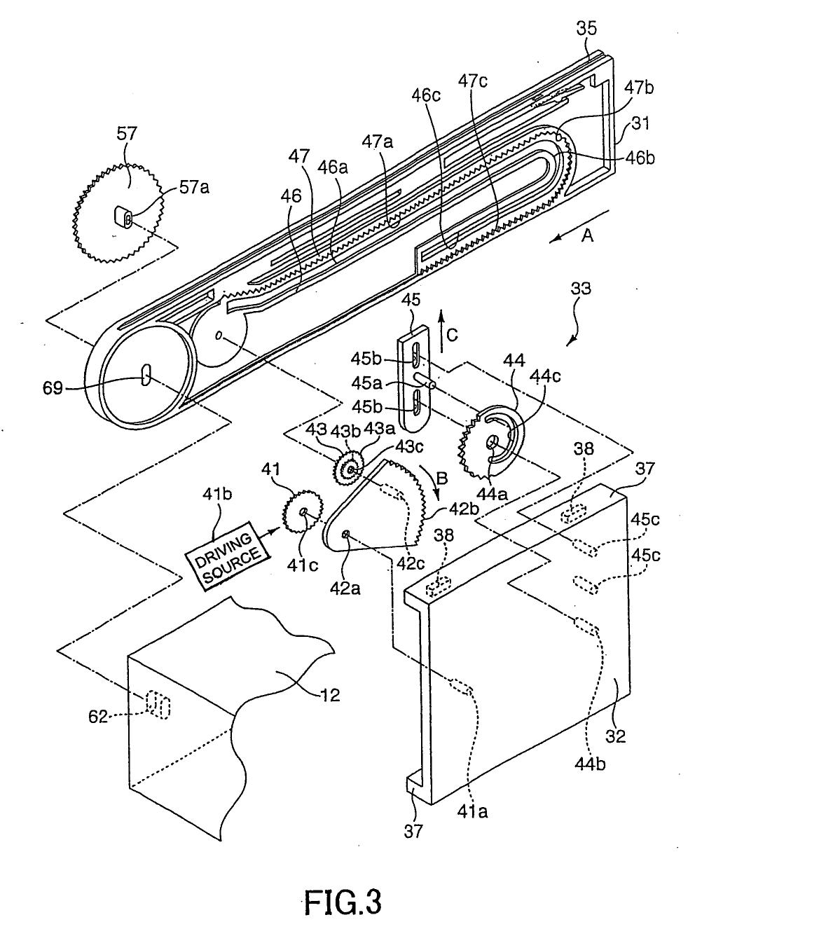

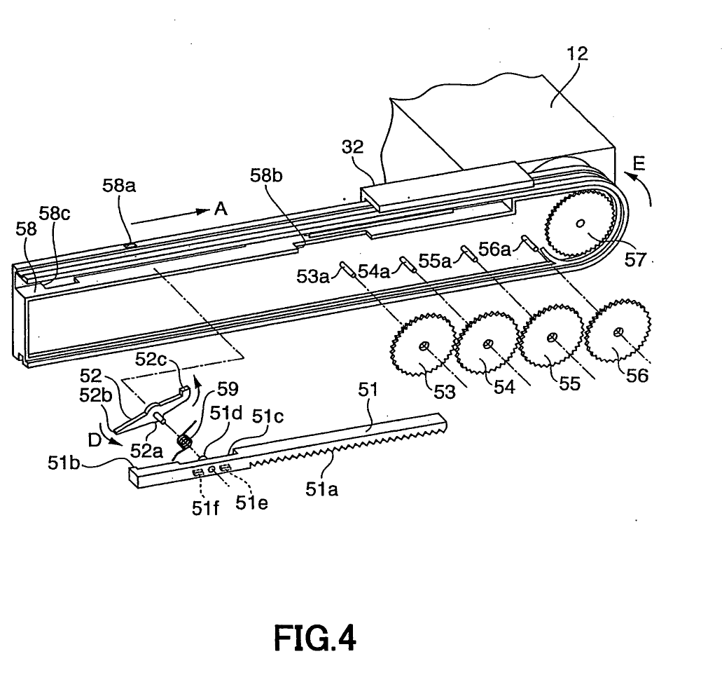

Specifically, the stocker transport mechanism 30 includes a pair of transport members 31, having fixedly mounted thereon both sides of the stocker 12, and a pair of guide members 32, mounted to the main body unit 11, as shown in FIGS. 3 and 4. Since the stocker transport mechanism 30 operates substantially similarly on both sides of the stocker, the measly sole side of the stocker transport mechanism 30 is hereinafter explained.

The transport member 31 is formed to a length corresponding to the transport distance of the stocker 12. A first driving unit 33 is provided on one surface side, mainly for transporting the stocker 12 across the inner and outer sides of the main body unit 11, whilst a second driving unit 34 is provided on the opposite surface side, mainly for causing rotation of the stocker on the outer side of the main body unit 11.

The transport member 31 is moved as it is guided by a guide member 32 on the inner and outer sides of the main body unit 11. In the upper and lower sides of the transport member 31, there is formed a guide groove 35 for extending along the longitudinal direction. The guide member 32 for guiding the transport member 31, secured to the main body unit 11, is substantially U-shaped to hold the transport member 31 in-between the upper and lower sides. The transport member 31 is mounted for movement across the inner and outer sides of the main body unit 11, by guide lugs 38, formed in edge parts 37, 37 of the guide member 32, engaging in the guide grove 35 of the transport member 31.

First, the first driving unit 33, adapted for causing movement of the transport member 31 on the inner and outer sides of the main body unit 11 for transporting the stocker 12, is explained with reference to FIG. 3.

Turning to FIG. 3, the first driving unit 33 includes a driving gear 41, to which the driving power is transmitted from a driving power source, a sector gear 42, mounted coaxially as the driving gear 41, a movement producing gear 43, mounted on the sector gear 42 for causing movement of the transport member 31, a cam gear 44, rotated by the sector gear 42, and an operating lever 45, moved by the cam gear 44.

The driving gear 41 includes a shaft opening 41c passed through by a first support shaft 41a, formed in the guide member 32, and is run in rotation by the driving power transmitted from a driving source 41b, formed by a driving motor provided to the main body unit 11, and a gear train. The sector gear 42 is mounted on a first support shaft 41a, formed on the guide member 32 and on which is mounted the driving gear 41.

The sector gear 42 is provided with a center shaft opening 42a, passed through by the first support shaft 41a, and with an arcuate gear 42b on its arcuate section. The arcuate gear 42b meshes with the cam gear 44. The sector gear 42 is rotated in a direction indicated by arrow B and in a direction opposite to that indicated by arrow B in FIG. 3, about the first support shaft 41a as the center of rotation. The sector gear 42 is further formed with a second support shaft 42c on which is mounted the movement producing gear 43.

The movement producing gear 43 includes a first gear part 43a of larger diameter and a second gear part 43b of lesser diameter, and has a shaft opening 43c in which is fixedly engaged the second support shaft 42c of the sector gear 42. The large-diameter first gear part 43a meshes with the driving gear 41 to receive the driving force from the driving gear 41 to cause movement of the transport member 31 in a direction indicated by arrow A and in a direction opposite to that indicated by arrow A in FIG. 3. The small-diameter second gear part 43b meshes with a rack gear 47 of the transport member 31.

The cam gear has a shaft opening 44a passed through by a third support shaft 44b formed on the guide member 32, and is rotated responsive to rotation of the sector gear 42. The cam gear 44 is formed with a cam groove 44c. This cam groove 44c is formed so as to be progressively increased in diameter from the center towards the rim.

The operating lever 45, moved by the cam gear 44, includes an operating pin 45a, engaged in the cam groove 44c of the cam gear 44, and a guide opening 45b, adapted for guiding movement in a direction perpendicular to the direction of movement of the transport member 31 as indicated by arrow C, and in a direction opposite to that indicated by arrow C in FIG. 3. The guide opening 45b is engaged by a guide lug 45c provided on the guide member 32. The operating lever 45, the operating pin 45a of which is engaged in the cam groove 44c of the cam gear 44, is moved in the direction as indicated by arrow C and in a direction opposite to that indicated by arrow C in FIG. 3.

The transport member 31, moved by the small-diameter second gear part 43b of the movement producing gear 43, is formed with a guide groove 46 engaged by the second gear part 43b. This guide groove 46 is made up by a first linear part 46a, a curved part 46b, continuing to the first linear part 46a, and a second linear part 46c, continuing to the first linear part 46a and extending parallel to the first linear part 46a, and is formed to an overall shape of an inverted C. The rack gear 47, meshing with the second gear part 43b, is formed in continuation to the guide groove 46. In similar manner, the rack gear 47 is made up by a first linear part 47a, a curved part 47b, continuing to the first linear part 47a, and a second linear part 47c, continuing to the first linear part 47a and extending parallel to the first linear part 47a, and is formed to an overall shape of an inverted C. When the second gear part 43b is rotating in the forward direction, that is, in a direction of pulling out the stocker 12 out of the main body unit 11, the transport member 31 is moved in the direction indicated by arrow In FIG. 3, in the first linear part 47a of the rack gear 47. When the second linear part 47c is reached via the curved part 47b, the transport member 31 is moved in the direction opposite to that indicated by arrow A in FIG. 3, for pulling the stocker 12 into the main body unit 11.

In the operation of the above-described first driving unit 33, the driving force from the driving source 41b is transmitted via driving gear 41 to the movement producing gear 43. When the stocker 12 is housed within the main body unit 11, the transport member 31 is housed within the main body unit 11. The second gear part 43b of the movement producing gear 43 is located at the distal end of the first linear part 47a of the rack gear 47. The sector gear 42 has been rotated in a direction opposite to the direction indicated by arrow B in FIG. 3, with the first support shaft 41a as the center of rotation. The operating pin 45a of the operating lever 45, engaged in the cam groove 44c of the cam gear 44, is located in the inner rim side end of the cam groove 44c of the cam gear 44, and has been rotated in the direction opposite to that indicated by arrow C in FIG. 3. As a result of rotation in the forward direction of the driving gear 41, the second gear part 43b of the movement producing gear 43, meshing with the driving gear 41, is moved progressively from the distal end of the first linear part 47a of the rack gear 47 towards the curved part 47b, whereby the transport member 31 is moved in the direction of arrow A in FIG. 3 for pulling out the stocker 12 out of the main body unit 11. When the second gear part 43b reaches the curved part 47b of the rack gear 47, the sector gear 42, having fixedly mounted thereon the movement producing gear 43, is rotated in the direction indicated by arrow B in FIG. 3, about the first support shaft 41a as the center of rotation. This causes rotation of the cam gear 44, meshing with the arcuate gear 42b, such that the operating pin 45a of the operating lever 45 is moved from the inner rim end towards the outer rim end of the cam groove 44c of the cam gear 44. The operating pin 45a is then moved in the direction indicated by arrow C in FIG. 3.

When rotated, the second gear part 43b is moved away from the curved part 47b to the second linear part 47c of the rack gear 47. This causes movement of the transport member 31, moved in the direction indicated by arrow A in FIG. 3, in the direction opposite to that indicated by arrow A, in which the stocker 12 is pulled into the inside of the main body unit 11. The second linear part 47c is formed to a length shorter than the first linear part 47a, so that, after once moving in the direction of arrow A in FIG. 3, the transport member 31 is slightly moved towards the main body unit 11, in the direction opposite to that indicated by arrow A.

Moreover, when pulling the transport member 31, protruded towards the main body unit 11, into the inside of the main body unit 11, the driving gear 41 is rotated in the reverse direction. This causes the second gear part 43b of the movement producing gear 43 to be moved from the first linear part 47a of the rack gear 47 towards the curved part 47b of the rack gear 47. During the time the second gear part 43b is moved along the second linear part 47c of the rack gear 47 towards the curved part 47b, the transport member 31 is moved in the direction opposite to that indicated by arrow A in FIG. 3 for protruding the stocker 12 out of the main body unit 11. When the second gear part 43b reaches the curved part 47b of the rack gear 47 to proceed towards the first linear part 47a, the sector gear 42, having fixedly mounted thereon the movement producing gear 43, is rotated in the direction of arrow B in FIG. 3, about the first support shaft 41a as the center of rotation. This causes rotation of the cam gear 44, meshing with the arcuate gear 42b, so that the operating pin 45a of the operating lever 45 is moved from the outer rim side end towards the inner rim side end of the cam groove 44c of the cam gear 44. The operating lever 45 is then moved in the direction opposite to that indicated by arrow C in FIG. 3. Until the time the second gear part 43b of the movement producing gear 43 reaches the distal end of the first linear part 47a of the rack gear 47, the transport member 31 proceeds in the direction opposite to that indicated by arrow A in FIG. 3 to pull the transport member 31 into the inside of the main body unit 11.

Referring to FIG. 4, the second driving unit 34, provided to the opposite side surface of the transport member 31 for causing rotation of the stocker 12 so that the major surface of the optical disc 1 housed in each disc housing section will be in substantially upstanding position, is now explained with reference to FIG. 4.

Referring to FIG. 4, the second driving unit 34 includes a slider 51, mounted for sliding movement to the transport member 31, a regulating member 52 for regulating the sliding movement of the slider 51, a first transmission gear 53, connected to the slider 51, a second transmission gear 54, meshing with the first transmission gear, a third transmission gear 55, meshing with the second transmission gear 54, a fourth transmission gear 56, meshing with the third transmission gear 55, and a rotation producing gear 57, meshing with the fourth transmission gear 56 to cause rotation of the stocker 12.

The slider 51 is a linear member which is mounted in a recessed guide groove 58 formed in the opposite surface of the transport member 31 for extending along the direction of arrow A and along the direction opposite to the arrow A in FIG. 4. The slider 51 is formed with a rack gear 51a meshing with a first transmission gear 63. The rack gear 51a meshes with a first transmission gear 53a via an opening 58b formed in the guide groove 58. One end side of the slider 51 is formed with an engagement recess 51b engaged by the distal end of the operating lever 45. This engagement recess 51b communicates with the surface of the transport member 31, having fixedly mounted thereon the operating lever 45, by a cut-out 58c formed in the guide groove 58, to permit the distal end of the operating lever 45 to be intruded into the recess. The slider 51 is also formed with an engagement recess 51c adjacent to the engagement recess 51b. In this engagement recess 51c, there is mounted a regulating member 52 for regulating the slide movement of the slider 51.

A rotation support part 52a, mounted to a support shaft 51d formed centrally of the engagement recess 51c of the slider 51, is formed at one end of the regulating member 52 mounted to the engagement recess 51c of the slider 51. On one side of the rotation support part 52a, a thrust part 52b, thrust by the distal end of the operating lever 45 id formed facing the engagement recess 51b, whereas, on the opposite side, there is formed a lock part 52c engaged in a lock opening 58a formed in the guide groove 58. A torsion coil spring 59, as a biasing member, has its coil part wound about the support shaft 51d formed in the engagement recess 51c, while having its one arm part retained by the regulating member 52 and having its other arm member retained by the engagement recess 51c, for basing the regulating member 52 in the direction of an arrow D in FIG. 4 to cause the lock part 52c to be engaged in the lock opening 58a. When the stocker 12 is housed within the main body unit 11, the lock part 52c of the regulating member 52 is engaged in the lock opening 58a of the guide groove 58, under the force of bias of the torsion coil spring 59, to inhibit the slide movement of the slider 51, on which is mounted the regulating member 52. The regulating member 52 has its thrust part 52b thrust by the distal end of the operating lever 45. Moreover, by engagement with the engagement recess 51b, the regulating member 52 is rotated in the direction opposite to that indicated by arrow D in FIG. 4, against the bias of the torsion coil spring 59, to release the locked state of the lock part 52c in the lock opening 58a. The slider 51 may now be slid along the guide groove 58 in the direction indicated by arrow A and in the direction opposite to that indicated by arrow A in FIG. 4.

Meanwhile, the rotation towards the lock part 52c of the regulating member 52 is prohibited by a rotation prohibiting lug 51e in the engagement recess 51c, while rotation thereof towards the thrust part 52b is prohibited by a rotation prohibiting lug 51f in the engagement recess 51c.

The first transmission gear 53 is carried by the support shaft 53a, formed on the opposite surface of the transport member 31, and meshes with the rack gear 51a of the slider 51. The second transmission gear 54 is carried by the support shaft 54a, formed on the opposite surface of the transport member 31, and meshes with the first transmission gear 53. The third transmission gear 55 is carried by the support shaft 55a, formed on the opposite surface of the transport member 31, and meshes with the second transmission gear 54. The fourth transmission gear 56 is carried by the support shaft 56a, formed on the opposite surface of the transport member 31, and meshes with the third transmission gear 55 and with the rotation producing gear 57.

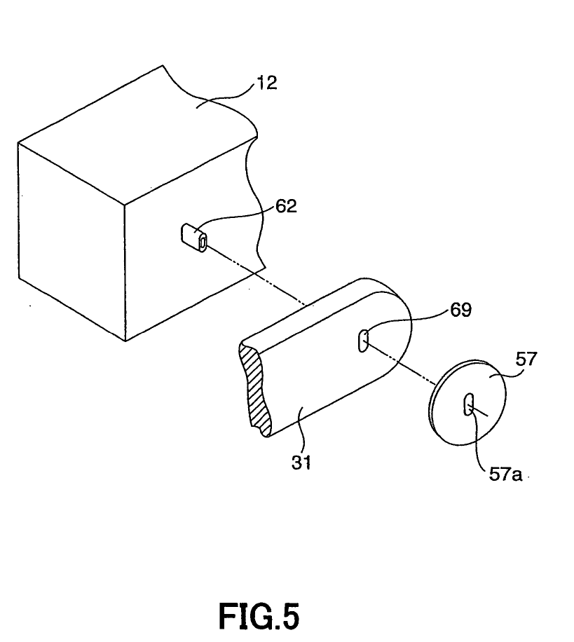

Referring to FIGS. 4 and 5, the rotation producing gear 57 is mounted on a rotational shaft 62 directly mounted to the stocker 12 via an insertion opening 61 of the transport member 31. The rotational shaft 62 has a non-circular cross-sectional shape, such as elliptical cross-sectional shape, in order to permit rotation of the rotational shaft in unison with the rotation producing gear 57. A shaft opening 57a of the rotation producing gear 57 is shaped in a similar manner. Hence, the stocker 12 is rotated in the direction indicated by arrow E and in the direction opposite to that indicated by arrow E in FIG. 4, in keeping with rotation of the rotation producing gear 57.

The operation of the second driving unit 34 is now explained. When the stocker 12 is housed in the main body unit 11, the regulating member 52 is engaged in the lock opening 58a of the guide groove 58, such as to prohibit the slide movement along the guide groove 58 of the slider 51, having fixedly mounted thereon the regulating member 52. When the transport member 31 commences to be moved in the direction indicated by arrow A in FIG. 4, in order to transport the stocker 12 to outside the main body unit 11, and the second gear part 43b of the movement producing gear 43, forming the first driving unit 33, reaches the curved part 47b of the rack gear 47, the sector gear 42, having fixedly mounted thereon the movement producing gear 43, is rotated in the direction opposite to that indicated by arrow B in FIG. 3, about the first support shaft 41a as the center of rotation. This causes rotation of the distal end of the operating lever 45 is then engaged in the engagement recess 51c of the slider 51, via the cut-out 58c formed in the guide groove 58, while thrusting the thrust part 52b of the regulating member 52. The regulating member 52 is then rotated in the direction indicated by arrow D in FIG. 4, against the bias of the torsion coil spring 59, about the support shaft 51d as the center of rotation, to cancel the state of lock of the lock part 52c in the lock opening 58a. The slider 51 may now be slid along the guide groove 58 in the direction indicated by arrow A and in the direction opposite to that indicated by arrow A in FIG. 4.

That is, by the distal end of the operating lever 45, mounted on the guide member 32, engaging in the engagement recess 51b, the slider 51 may be slid in the guide groove 58 relative to the transport member 31. When the second gear part 43b of the movement producing gear 43 of the first driving unit 33 reaches the second linear part 47c of the rack gear 47, and the transport member 31 performs the movement in the direction opposite to that indicated by arrow A in FIG. 4, the slider 51 is slid in the direction indicated by arrow A in FIG. 4 relative to the transport member 31. This causes rotation of the first transmission gear 53 meshing with the rack gear 51a of the slider 51, and rotation of the rotation producing gear 57 through the second to fourth transmission gears 54 to 56. The stocker 12, rotated in unison with the rotation producing gear 57, mounted to the rotational shaft 62, provided to the stocker 12, is rotated in the direction indicated by arrow E in FIG. 4.

When the slider 51 is slid relative to the transport member 31 in the direction opposite to that indicated by arrow A in FIG. 4, the first transmission gear 53, meshing with the rack gear 51a of the slider 51, is rotated to cause rotation of the rotation producing gear 57 through the second to fourth transmission gears 54 to 56. The stocker 12, rotated in unison with the rotation producing gear 57, mounted to the rotational shaft 62, provided to the stocker 12, is rotated in the direction opposite to that indicated by arrow E in FIG. 4.

The operation of the disc transport apparatus 10, constructed as described above, is now explained.

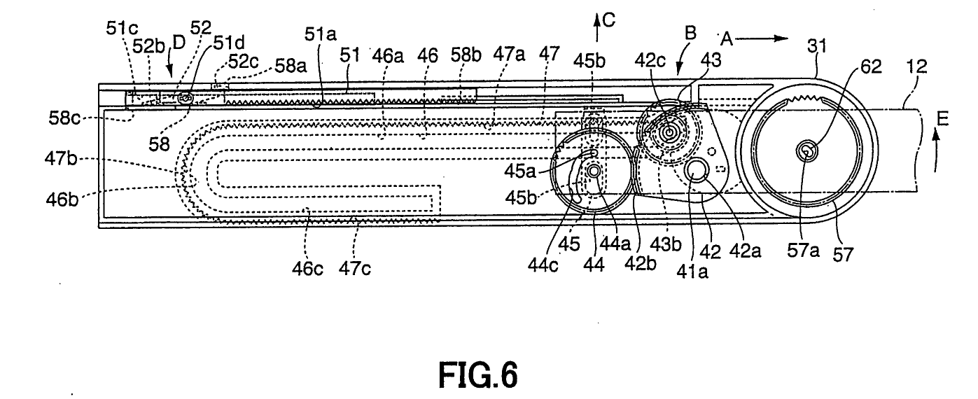

First, the operation of exchanging the optical disc 1 is explained. Referring to FIG. 6, the transport member 31 of the first driving unit 33 is housed in the main body unit 11, when the stocker 12 is housed in the main body unit 11, while the second gear part 43b of the movement producing gear 43 is located at the distal end of the first linear part 47a of the rack gear 47. The sector gear 42 has been rotated in the direction opposite to that indicated by arrow B in FIG. 6, while the operating pin 45a of the operating lever 45, engaging in the cam groove 44c of the cam groove 44, is located at an inner end of the cam groove 44c, and has been moved in the direction opposite to that indicated by arrow C in FIG. 6. Hence, the regulating member 52 of the second driving unit 34 has the lock part 52c engaged in the lock opening 58a of the guide groove 58, under the bias of the torsion coil spring 59, and hence the slider 51, having fixedly mounted thereon the regulating member 52, is prohibited from performing the sliding movement along the guide groove 58. Until the time the second gear part 43b of the movement producing gear 43 reaches the curved part 47b of the rack gear 47 of the transport member 31, with the rotation of the driving gear 41 in the forward direction, the transport member 31 is moved in the direction indicated by arrow A in FIG. 6, so as to be protruded to outside the main body unit 11.

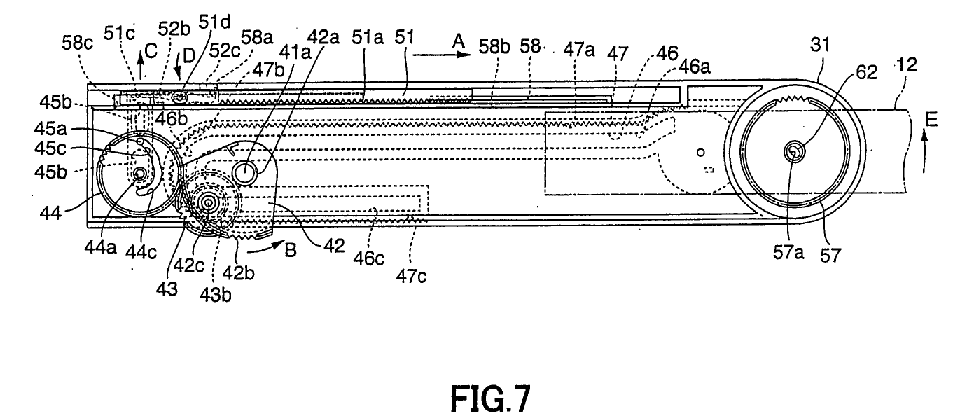

When the second gear part 43b reaches the curved part 47b of the rack gear 47, as shown in FIG. 7, the sector gear 42, having fixedly mounted thereon the movement producing gear 43, is rotated in the direction indicated by arrow B in FIG. 7, about the first support shaft 41a as the center of rotation. This causes rotation of the cam gear 44, meshing with the arcuate gear 42b, such that the operating pin 45a of the operating lever 45 is moved from the inner rim side end towards the outer rim end of the cam groove 44c of the cam gear 44. The operating lever 45 is then moved in the direction indicated by arrow C in FIG. 7 and is intruded into the engagement recess 51c of the slider 51. The distal end of the operating lever 45 is engaged via cut-out 51c in the slider 51, via cut-out 58c formed in the guide groove 58, while thrusting the thrust part 52b of the regulating member 52. The regulating member 52 is then rotated in the direction opposite to that indicated by arrow D in FIG. 7, against the bias of the torsion coil spring 59, about the support shaft 51d as the center of rotation. This releases the lock of the lock part 52c in the lock opening 58a, with the slider 51 then being slidable along the guide groove 58 in the direction indicated by arrow A in FIG. 7.

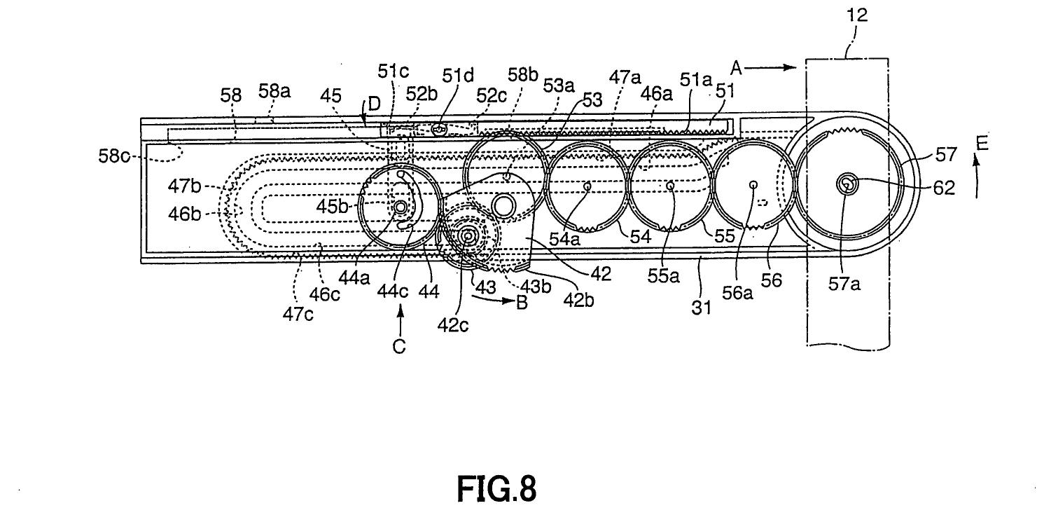

On further rotation, the second gear part 43b of the movement producing gear 43 is moved from the curved part 47b to the second linear part 47c of the rack gear 47, as shown in FIG. 8. The transport member 31, moved in the direction indicated by arrow A in FIG. 8, is moved in the direction opposite to that indicated by arrow A in FIG. 8. The second linear part 47c is shorter in length than the first linear part 47a, so that the transport member 31, after movement in the direction indicated by arrow A in FIG. 8, is moved a slight distance towards the main body unit 11 in the direction opposite to that indicated by arrow A in FIG. 8. When the second gear part 43b of the movement producing gear 43 is being moved on the second linear part 47c of the rack gear 47, the slider 51 is slid in the guide groove 58 in the direction indicated by arrow A in FIG. 8, with respect to the transport member 31, by engagement in the engagement recess 51b of the distal end of the operating lever 45 mounted to the guide member 32. The first transmission gear 53, meshing via opening 58b of the guide groove 58 with the rack gear 51a of the slider 51, is rotated with the sliding of the slider 51 to cause rotation of the rogation producing gear 57 through the second to fourth transmission gears 54 to 56. The stocker 12, rotated in unison with the rotation producing gear 57, mounted to the rotational shaft 62, provided to the stocker 12, is rotated in the direction indicated by arrow E in FIG. 8.

Thus, the stocker 12 is substantially in the upstanding state, outside the main body unit 11, as shown in FIG. 1, so that the user is able to grip the outer rim part of the optical disc 1 for exchanging the disc extremely readily.

The operation of pulling the stocker 12 into the inside of the main body unit 11 is now explained. The driving gear 41 is rotated in reverse. The second gear part 43b of the movement producing gear 43 is moved from the first linear part 47a towards the curved part 47b of the rack gear 47. When the second gear part 43b is moved along the second linear part 47c of the rack gear 47 towards the curved part 47b, the transport member 31 is moved in the direction opposite to that indicated by arrow A in FIG. 8. When the second gear part 43b of the movement producing gear 43 is moved from the second linear part 47a towards the curved part 47b, the stocker 12 is moved in the direction of being protruded from the main body unit 11. At this time, the slider 51 is slid in the direction opposite to that indicated by arrow A in FIG. 8, so that the rotation producing gear 57, mounted to the rotational shaft 62 via first to fourth transmission gears 53 to 56, is rotated in reverse to cause rotation of the stocker 12 in the direction opposite to that indicated by arrow E in FIG. 8.

When the second gear 43b has reached the curved part 47b of the rack gear 47 to proceed towards the first linear part 47a, the sector gear 42, having fixedly mounted thereon the movement producing gear 43, is rotated in the direction opposite to that indicated by arrow B in FIG. 3, about the first support shaft 41a as the center of rotation. This causes rotation of the cam gear 44, meshing with the arcuate gear 42b, such that the operating pin 45a of the operating lever 45 is moved from the outer rim side end of the inner rim side end of the cam groove 44c of the cam gear 44. The operating lever 45 is then moved in the direction opposite to that indicated by arrow C in FIG. 3. This causes the distal end of the operating lever 45 to be retreated from the engagement recess 51c of the slider 51, via cut-out 58c formed in the guide groove 58. The regulating member 52 is rotated in the direction indicated by arrow D in FIG. 6, under the bias of the torsion coil spring 59, to produce the locked state of the lock part 52c in the lock opening 58a, with the slider 51 being prohibited from performing the slide movement.

During the time until the second gear part 43b of the movement producing gear 43 reaches the distal end of the first linear part 47a of the rack gear 47, the transport member 31 proceeds in the direction opposite to that indicated by arrow A in FIG. 3 to pull the stocker 12 mounted to the transport member 31 into the inside of the main body unit 11.

When reproducing the optical disc 1 in the stocker 12, the optical disc 1 is transported from within the stocker 12 to the reproducing unit 16 by a disc transport mechanism, not shown. When the optical disc 1 has been transported to the reproducing unit 16, the recorded information signals are reproduced. That is, the optical disc 1 illuminates a light beam to the optical disc 1, rotated by the disc rotating driving unit 22, and detects the return light beam, reflected back from the optical disc 1, to reproduce the information signals recorded thereon.

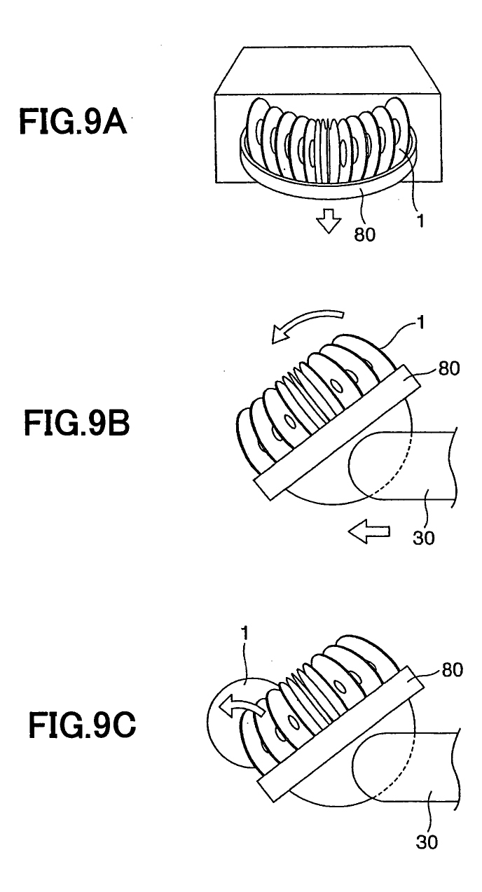

Although the case in which, in the disc transporting apparatus, plural optical discs 1 are stacked together and housed in this state in the stocker 12 has been explained, the structure of the stocker 12, housing the plural optical discs 1, may be as shown in FIGS. 9(A) to 9(C). In a stocker 80, shown in FIG. 9(A), plural optical disc 1 are set upright and housed in a radial array. This stocker 80 is transported by the above-described stocker transport mechanism 30 into and out of the main body unit 11. After the stocker 12 is pulled out from the main body unit 11, the stocker 12, shown in FIG. 9(B), is rotated towards the user lying on the front side of the main body unit 11, such that the user may grip the outer rim of the disc to exchange it, as shown in FIG. 9(C).

Although the disc transport apparatus 10 uses the optical disc 1 as the recording medium, the present invention may also be applied to a recording medium transporting apparatus, configured for transporting a disc-shaped recording medium, such as a magnetic disc, a magneto-optical disc or a plate-shaped optical disc.

Although the stocker 12 is in a substantially upstanding state, outside the main body unit 11, the stocker 12 according to the present invention may also be rotated at an angle different from that during transport inside the main body unit 11, for thereby tilting the optical disc 1.

The disc changer apparatus, embodying the present invention, is hereinafter explained.

In the following explanation, the parts or components equivalent to those of the disc transport apparatus 10 are omitted and the same reference numerals are used to depict these parts or components.

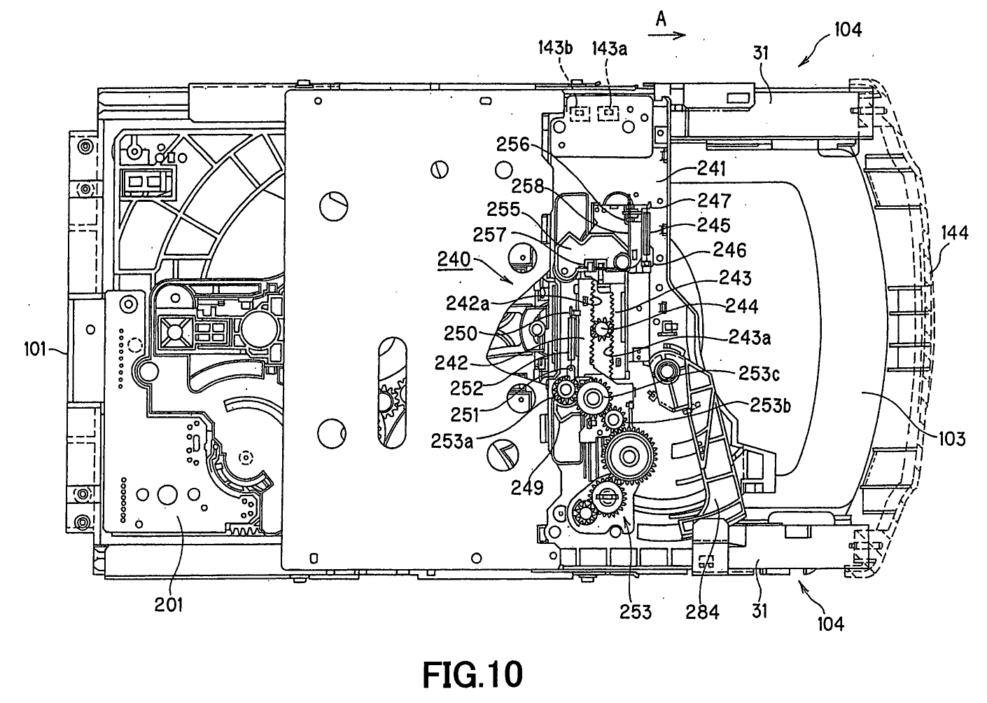

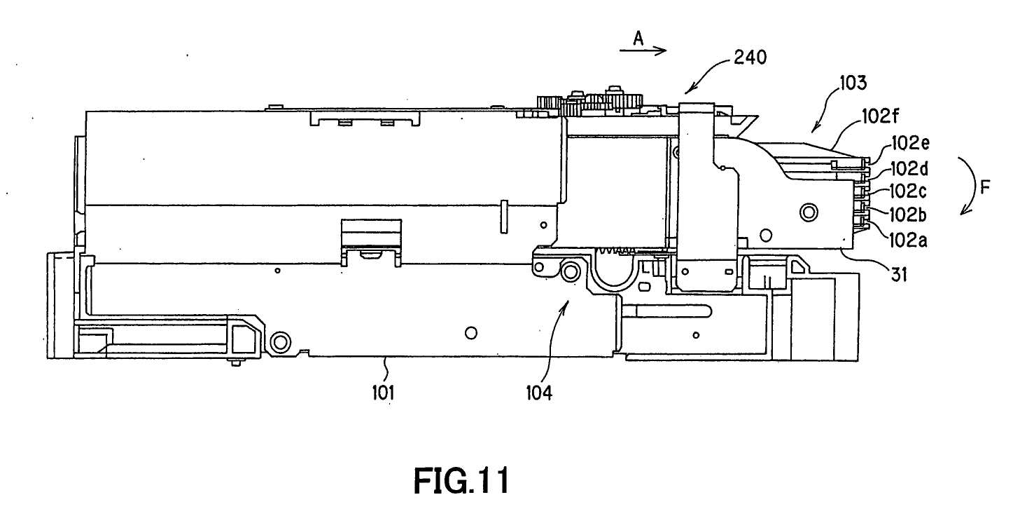

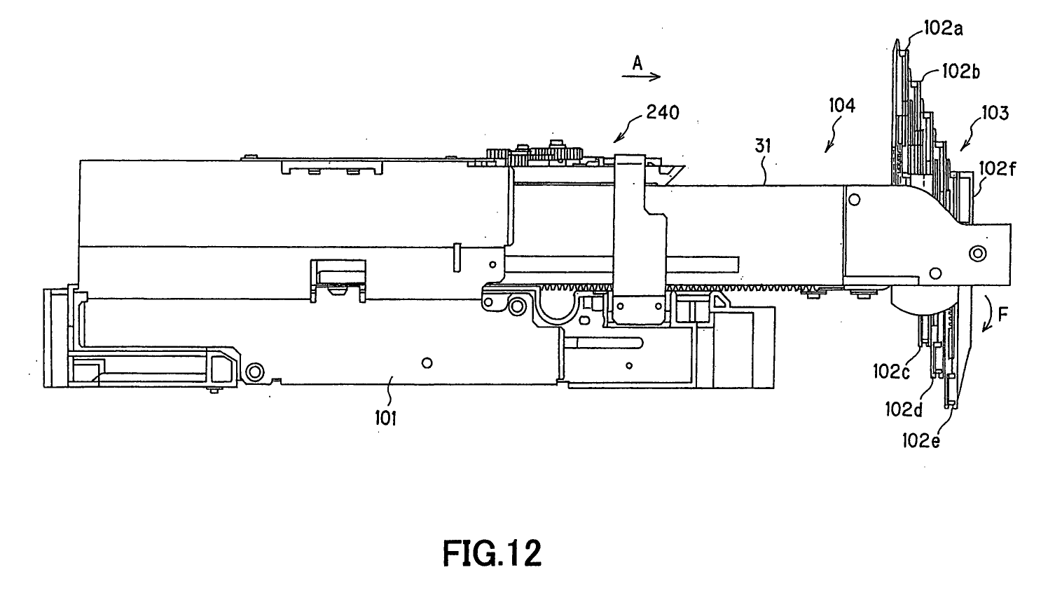

Referring to FIGS. 10 to 14, the disc changer apparatus of the present invention includes a main body unit 101, a stocker 103 in which plural disc housing components 102a to 102f, each housing the optical disc 1, are stacked in plural layers, and a stocker transport mechanism 104, configured for transporting the stocker 103 between a housed position in which the stocker is pulled into and housed within the main body unit 101, as shown in FIG. 11, and a pullout position in which the stocker is pulled out of the main body unit 101, as shown in FIG. 12.

The present disc changer apparatus is featured by causing the rotation of the stocker 103 in one direction, that is, in a direction indicated by arrow F, so that, when the stocker transport mechanism 104 has transported the stocker 103 up to a housed position in the main body unit 101, the disc insertion/ejection openings 153 of the disc housing components 102a to 102f are directed towards the inside of the main body unit 101. The present disc changer apparatus is also featured by causing the rotation of the stocker 103 in the opposite direction, that is, in a direction opposite to that indicated by arrow F, so that, when the stocker transport mechanism 104 has transported the stocker 103 up to a pullout position outside the main body unit 101, the disc insertion/ejection openings 153 of the disc housing components 102a to 102f are directed upwards, and by sequentially offsetting the disc housing components 102a to 102f along the direction of inserting/ejecting the optical disc 1. That is, with the present disc changer apparatus, the disc housing components 102a to 102f are sequentially offset in the up-and-down direction from the substantially upstanding position, for facilitating the exchange of the optical disc 1.

Specifically, the stocker transport mechanism 104 includes a first driving unit 105 for transporting the stocker 103 into and out of the main body unit 101, and a second driving unit 106 for rotating the stocker 103 on the outer side of the main body unit 101 and for vertically shifting the disc housing components 102a to 102e.

Of these, the first driving unit 105 has substantially the same structure as that of the first driving unit 33 and hence is not explained specifically.

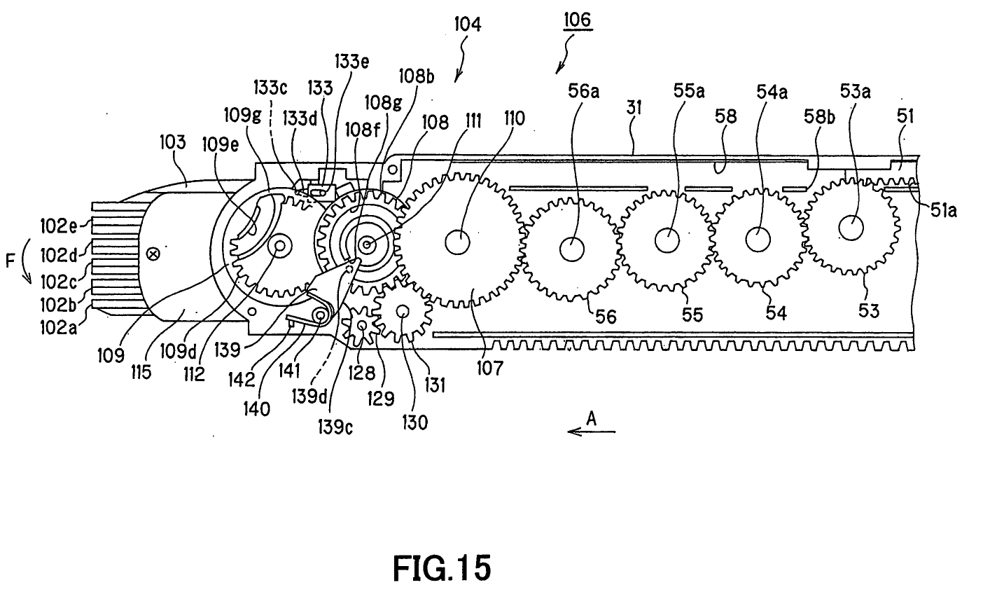

Turning to FIGS. 15 to 17, the second driving unit 106 includes, in addition to the structure of the second driving unit 34, a fifth transmission gear 107, meshing with the fourth transmission gear 56, a sixth transmission gear 108, meshing with the fifth transmission gear 107, and a seventh transmission gear 109, meshing with the sixth transmission gear 108, in place of the rotation producing gear 57 described above.

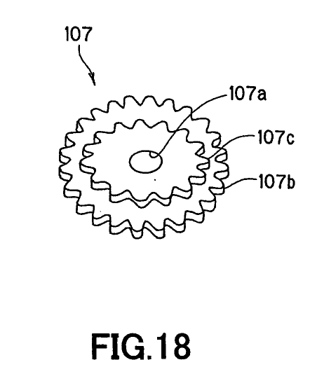

Turning to FIG. 18, the fifth transmission gear 107 includes a shaft opening 107a, in its center, a first gear 107b, on its one major surface, and a second gear 107c, smaller in diameter than the first gear 107b, on its opposite major surface side. Turning to FIGS. 15 to 17, the fifth transmission gear 107 is mounted in position by a support shaft 110 on the opposite surface of the transport member 31 being passed through the shaft opening 107a and by the first gear 107b meshing with the fourth transmission gear 56.

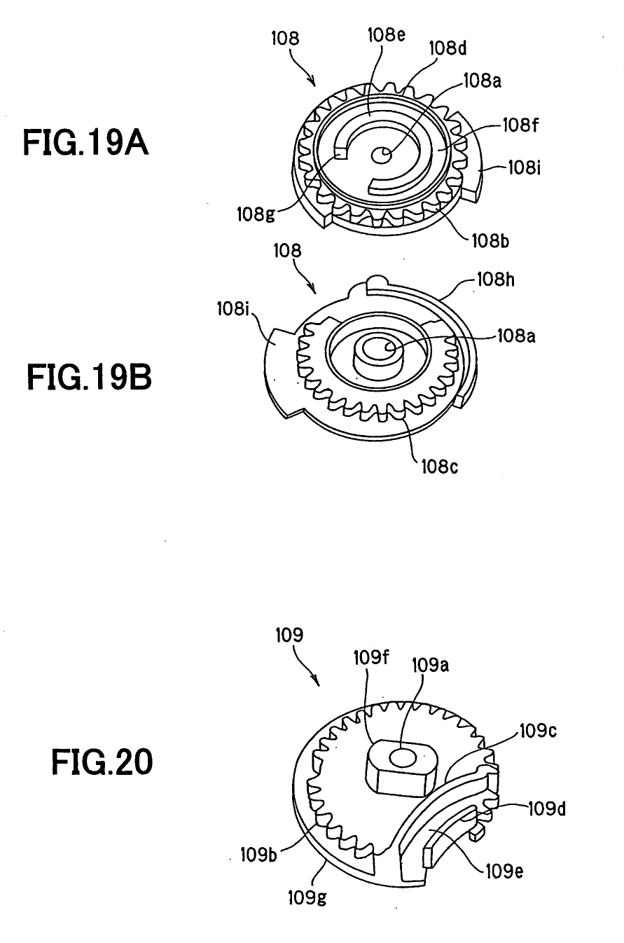

Referring to FIG. 19, the sixth transmission gear 108 has a center shaft opening 108a, a first gear part 108b on its one major surface and a second gear part 108c on its opposite major surface. The second gear part 108c is smaller in diameter than the first gear part 108b and is formed for extending a preset angular extent about the shaft opening 108a as center. On the one major surface of the sixth transmission gear 108, an outer rim side wall section 108d and an inner rim side wall section 108e, about the shaft opening 108a as center, and a guide groove 108f is formed between the outer peripheral wall section 108d and the inner rim side wall section 108e. In the inner rim side wall section 108e, there is formed a cut-out 108g for extending a preset angular extent. On the opposite major surface of the sixth transmission gear 108, there is formed an upstanding guide wall section 108h for extending a preset angular extent along the outer rim. On a site on the outer rim of the sixth transmission gear 108, opposite to the guide wall section 108h of the sixth transmission gear 108, there is formed a rib 108i for extending a preset angular extent.

Referring to FIGS. 15 to 17, the sixth transmission gear 108 is mounted in position by a having a support shaft 111 passed through the center shaft opening 108a and by having the first gear part 108b engaged with the second gear 107c of the fifth transmission gear 107. The support shaft 111 is provided to the opposite side surface of the transport member 31.

Referring to FIG. 20, the seventh transmission gear 109 has a center shaft opening 109a and a gear part 109b on its one major surface for extending a preset angular extent about the shaft opening 109a as center. On one major surface of the seventh transmission gear 109, an outer peripheral wall 109c and an inner peripheral wall 109d, both arcuate in profile, having a point lying on the outer side of the outer rim of the seventh transmission gear 109, are formed upright for extending between both ends of the gear part 109b. A guide groove 109e, engaged by the guide wall 108h of the sixth transmission gear 108, is formed between the outer peripheral wall section 109c and the inner peripheral wall section 109e. Centrally of the seventh transmission gear 109, there is protuberantly formed a cap 109f having the shaft opening 109a. From the outer rim of the seventh transmission gear 109, there is formed a rib 109g for extending a preset angular extent.

Referring to FIGS. 15 to 17, the seventh transmission gear 109 is mounted in position, by having a support shaft 112 passed through the shaft opening 109a and by having the gear part 109b engaged with the second gear part 108c of the sixth transmission gear 108. The support shaft 112 is provided to the opposite surface of the transport member 31.

Thus, with the present second driving unit 106, when the first transmission gear 53, meshing with the rack gear 51a of the slider 51 via opening 58b of the guide groove 58, is rotated in unison with the sliding movement of the slider 51, the fifth to seventh transmission gears 107 to 109 are rotated through the second to fourth transmission gears 54 to 107.

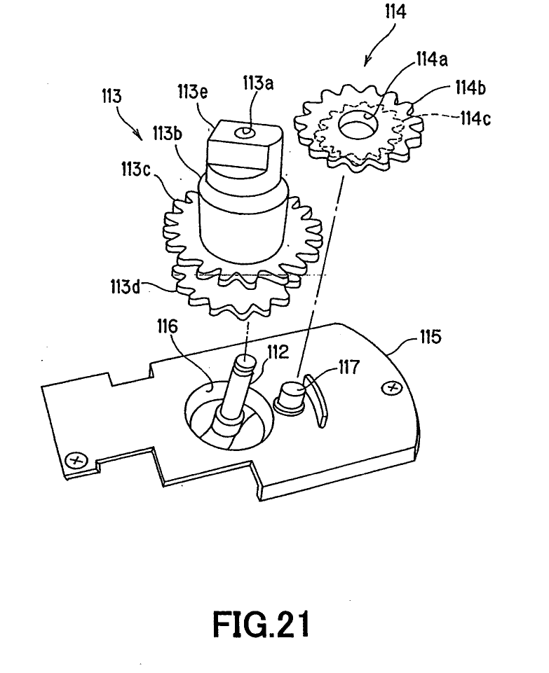

The second driving unit 106 includes an eighth transmission gear 113 and a rotational gear 114 meshing with the eighth transmission gear 113 for causing rotation of the stocker 103. The eighth transmission gear 113 is mounted on the inner surface of the transport member 31, shown in FIG. 21, coaxially with the seventh transmission gear 109 for rotation in unison with the seventh transmission gear 109. The eighth transmission gear 113 and the rotational gear 114 are rotationally mounted to cover members 115 provided to both lateral sides of the stocker 103.

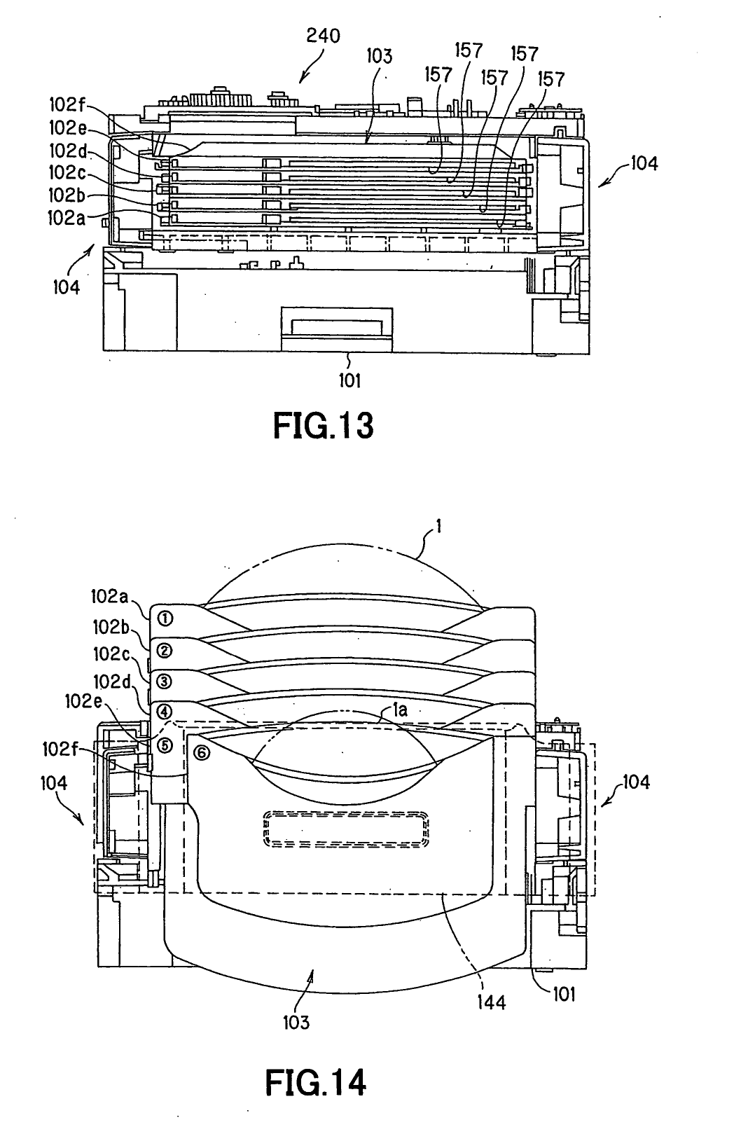

Specifically, the cover member 115 is used for guiding the sliding of the five stacked disc housing components 102a to 102e in the offsetting direction, and is screwed to both lateral sides of the third disc housing component 102c as counted from the bottom side of five disc housing components 102a to 102e. Meanwhile, the uppermost disc housing component 102f is dedicated for housing a small-sized disc of 8 cm in diameter smaller than the optical disc 1 of 12 cm in diameter accommodated in each of the five disc housing components 102a to 102e, as shown in FIGS. 13 and 14. This disc housing component 102f, dedicated to the small-sized optical disc, is structurally unified to the subjacent disc housing component 102e.

Referring to FIG. 21, the cover member 115 is provided with the support shaft 112 for having fixedly mounted thereon the seventh and eighth transmission gears 109, 113, an opening 116 for exposing the support shaft 112 to outside and a support shaft 117 for having fixedly mounted thereon the rotational gear 114.

The eighth transmission gear 113 includes a hub 113b, having a center shaft opening 113a, a rotation producing gear 113c, mounted on one side of the hub 113b for engaging with the rotational gear 114 and a first pinion 113d on the opposite side of the hub 113b for being intruded from the opening 116 of the cover member 115 towards the stocker. The distal end of the hub 113b towards the transport member 31 is formed as a fitting lug fitted to a cap 109f of the seventh transmission gear 109 via a through-hole, not shown, formed in the transport member 31. This fitting protrusion 113e has the shape of a partially flattened round shaft in order to prevent it from being rotated within the cap 109f.

This eighth transmission gear 113 is mounted in position by having a support shaft 112 of the cover member 115 passed through shaft opening 113a and by having the fitting lug 113e of the hub 113b fitted to the cap 109f of the seventh transmission gear 109. Thus, the rotation producing gear 113c and the first pinion 113d of the eighth transmission gear 113 are rotatable in unison with the seventh transmission gear 109.

The rotational gear 114 includes a center shaft opening 114a, a first gear part 114b on one major surface and a second gear part 114c smaller in diameter than the first gear part 114b. The rotational gear 114 is mounted in position by having the support shaft 117 passed through the shaft opening 114a of the rotational gear 114 and by having the second gear part 114c engaged by the rotation producing gear 113c.

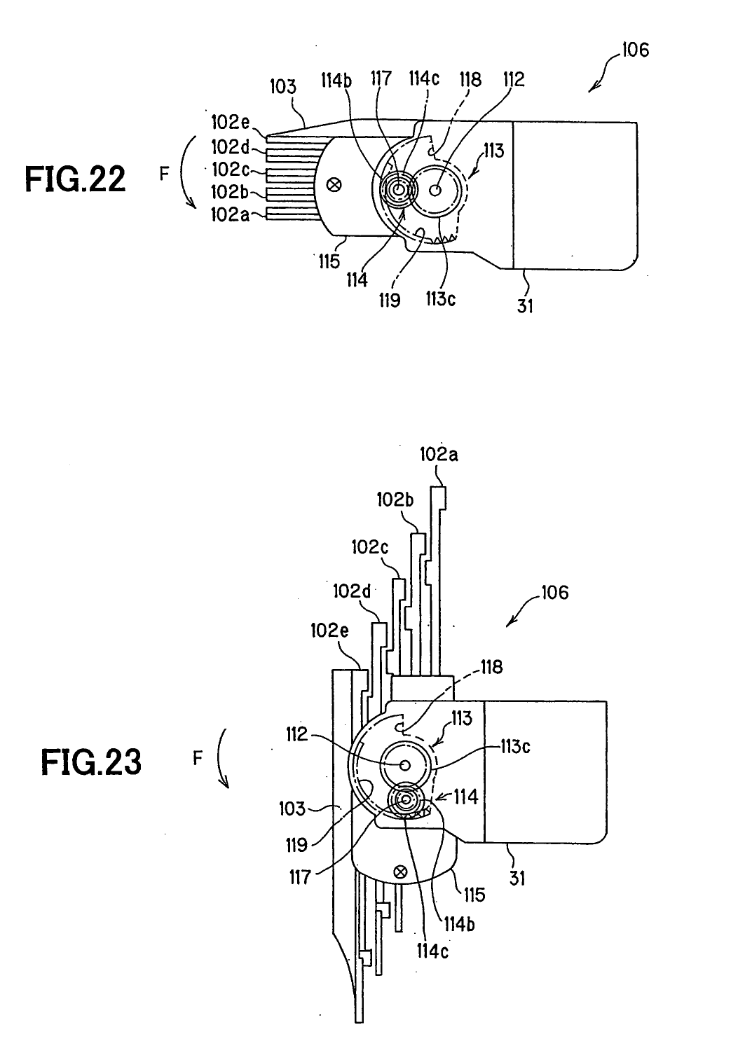

The one surface of the transport member 31, facing the cover member 115, on which are rotationally mounted the eighth transmission gear 113 and the rotational gear 114, is formed with a housing recess 118, for housing the rotation producing gear 113c and the rotational gear 114, and an arcuate rack gear 119, as shown in FIGS. 22 and 23. The arcuate rack gear 119, formed on the inner lateral surface of the housing recess 118, meshes with the first gear part 114b of the rotational gear 114. The arcuate rack gear is formed over an extent of rotation of the stocker 103, that is, over approximately 90°.

Thus, with the second driving unit 106, when the eighth transmission gear 113 is rotated in unison with the seventh transmission gear 109, the rotational gear 114, meshing with the rotation producing gear 113c, meshes with the rack gear, as the rotational gear 114 is rotated, whereby the stocker 103 is rotated in a direction indicated by arrow F and in a direction opposite to that indicated by arrow F, between the state in which the major surfaces of the disc housing components 102a to 102e are directed substantially parallel to the transport direction of the stocker 103, as shown in FIG. 22, and the state in which the major surfaces of the disc housing components 102a to 102f are directed substantially at right angles to the transport direction of the stocker 103, as shown in FIG. 23.

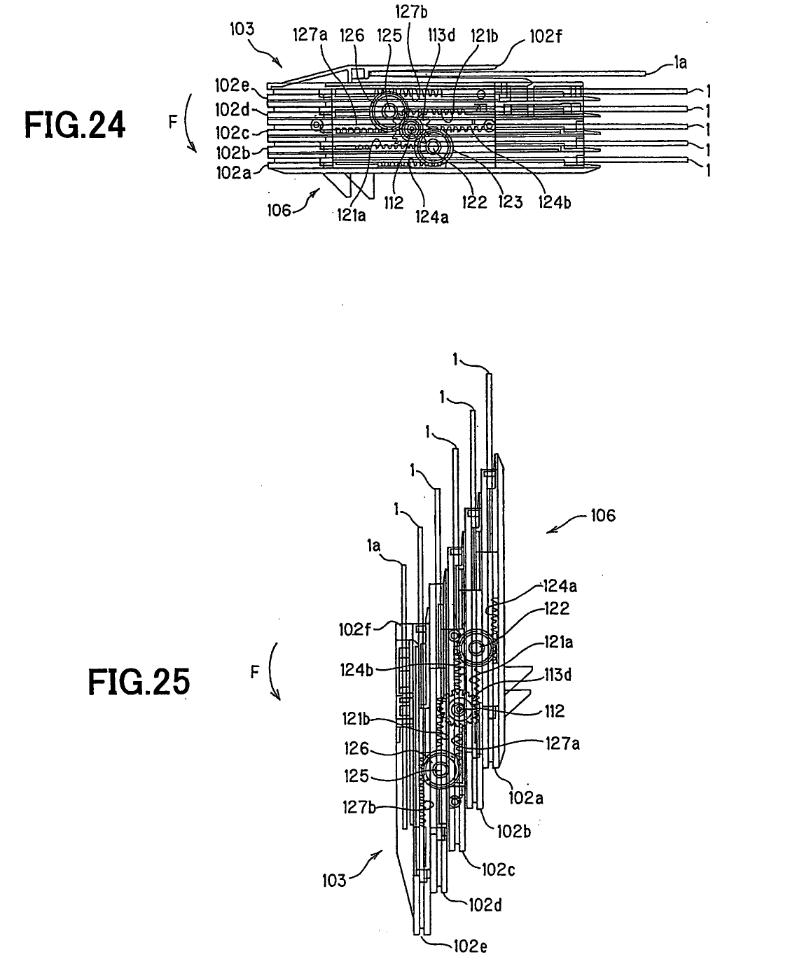

On the inner side of the cover member 115, shown in FIGS. 24 and 25, the second driving unit 106 includes a slide mechanism for sequentially offseting the disc housing components 102a to 102e in a direction substantially at right angles to the transport direction, in unison with the rotation of the stocker 103.

Specifically, out of the five stacked disc housing components 102a to 102e, the second and fourth disc housing components as counted from the bottom, that is, the disc housing components 102b and 102d, are provided with first rack gears 121a, 121b, on the lateral sides thereof, these first rack gears meshing with a first pinion 113d intruded from an opening 116 of the cover members 115 mounted on both lateral sides of the third disc housing component 102c as counted from the bottom side. The first and third disc housing components as counted from the bottom, that is, the disc housing components 102a and 102c, are provided on the lateral sides thereof with second rack gears 124a, 124b, meshing with a second pinion 123 carried by support shafts 122 formed on the lateral sides of the second disc housing component 102b as counted from the bottom. The third and fifth disc housing components as counted from the bottom, that is, the disc housing components 102c and 102e, are provided on the lateral sides thereof with third rack gears 127a, 127b, meshing with a third pinion 126 carried by support shafts 125 formed on the lateral sides of the fourth disc housing component 102d as counted from the bottom.

Of these, the first pinion 113d is arranged at a mid portion of each lateral side of the of the third disc housing component 102c as counted from the bottom, and causes the second and fourth disc housing components 102b, 102d as counted from the bottom to be slid in opposite directions to each other, relative to the third disc housing component 102c as counted from the bottom, by the meshing thereof with the first rack gears 121a, 121b. The second pinion 123 is arranged on one lateral side of the second disc housing component 102b as counted from the bottom, and causes the second disc housing component 102b as counted from the bottom to be slid in opposite directions to each other, relative to the second disc housing component 102b as counted from the bottom, by the meshing thereof with the second rack gears 124a, 124b. The third pinion 126 is arranged on the other lateral side of the fourth disc housing component 102d as counted from the bottom, and causes the third and fifth disc housing component 102c, 102e as counted from the bottom to be slid in opposite directions to each other, relative to the fourth disc housing component 102d as counted from the bottom, by the meshing thereof with the third rack gears 127a, 127b.

Thus, with the second driving unit 106, when the eighth transmission gear 113 is rotated in unison with the seventh transmission gear 109, the second and fourth disc housing components as counted from the bottom 102b, 102d are slid in opposite directions to each other, with the first pinion 113d, mounted to the third disc housing component as counted from the bottom, as center, as the first pinion 113d is kept in rotation. The lowermost disc housing component 102a is then slid in the same direction as the second disc housing component 102b as counted from the bottom, relative to the third disc housing component 102c as counted from the bottom, about the second pinion 123 as center. This second pinion 123 is mounted to the second disc housing component 102b as counted from the bottom slid in one direction. On the other hand, the fifth disc housing component as counted form the bottom is then slid in the same direction as the fourth disc housing component 102d as counted from the bottom, relative to the third disc housing component 102c as counted from the bottom, about the third pinion 123 as center. This third pinion 127 is mounted to the fourth disc housing component 102d, as counted from the bottom, slid in the other direction. In this manner, the disc housing components 102a to 102e are slid between the state in which the disc housing components are stacked in a substantially aligned state in the stacking direction as shown in FIG. 24 and the state in which the disc housing components are sequentially offset in a direction perpendicular to the stacking direction as shown in FIG. 25.

Meanwhile, the above-described second driving unit 106 is arranged in each of two transport members 31 carrying both sides of the stocker 103. The second driving unit 34 and the fifth transmission gear 107, meshing with the fourth transmission gear 56 in place of the rotation producing gear 57, are arranged on only one side transport members 31.

For this reason, a transmission mechanism for transmitting the driving force, transmitted to the fifth transmission gear 107, arranged on one of the transport members 31, to the sixth transmission gear 108, arranged on the other transport members 31 is provided between the paired transport members 31 carrying both sides of the stocker 12, as shown in FIGS. 15 to 17. Specifically, this transmission mechanism is made up by a connecting shaft 128, rotationally carried by a connecting member, not shown, interconnecting the paired transport members 31, coupling gears 129, mounted to both ends of the connecting shaft 128, and an intermediate gear 131 meshing with the coupling gears 129 and with the sixth transmission gear 108 and which is mounted in position by a support shaft 130 provided to the opposite side surface of the transport members 31. In this manner, the second driving units 106, arranged on the support shafts 130, provided to the opposite side surface of the transport member 31, may be driven in timed relation to each other.

With the above-described stocker transport mechanism 104, when the stocker 103, shown in FIGS. 10, 11 and 13, is in the housing position in the main body unit 101, the stocker 103 is in such a state in which the disc insertion/ejection openings 153 of the disc housing components 102a to 102f are directed to the inner sides of the main body unit 101 and the major surfaces of the disc housing components 102a to 102f are substantially parallel to the transport direction of the stocker 103.

The transport member 31 of the first driving unit 33 is housed within the main body unit 101, the second gear part 43b of the movement producing gear 43 is positioned at the distal end of the first linear part 47a of the rack gear 47, the sector gear 42 has been rotated in a direction opposite to that indicated by arrow B in FIG. 6, about the first support shaft 41a as center, and the operating pin 45a of the operating lever 45, engaged in the cam groove 44c of the cam gear 44, is located at the inner end of the cam groove 44c, and has been moved in a direction opposite to that indicated by arrow C in FIG. 6. The regulating member 52 of the second driving unit 106 is in such a state in which the lock part 52c is engaged in the lock opening 58a of the guide groove 58. The slider 51, having fixedly mounted thereon the regulating member 52, is prohibited from performing a slide movement along the guide groove 58.

In transporting the stocker 103 in the housed position to a pullout position outside the main body unit 101, the drive gear 41 is first rotated in the forward direction. This causes the second gear part 43b of the movement producing gear 43, meshing with driving gear 41, is progressively moved from the distal end of the first linear part 47a of the rack gear 47 towards the curved part 47b. This causes movement of the transport member 31 in the direction of arrow A for pulling out the stocker 103 to outside the main body unit 101, until the second gear part 43b of the movement producing gear 43 reaches the curved part 47b of the rack gear 47.

When the second gear part 43b of the movement producing gear 43 is rotated further and moved from the curved part 47b up to the second linear part 47c of the rack gear 47, the transport member 31, which has been moved in the direction of arrow A, is moved in the direction opposite to that indicated by arrow A of pulling the stocker 103 into the inside of the main body unit 101. The second linear part 47c is of a length shorter than the first linear part 47a and hence the transport member 31 is once moved to its full stroke in the direction of arrow A, after which it is moved slightly towards the main body unit 101, that is, in the direction opposite to that indicated by arrow A. This position is the pullout position of the stocker 103, indicated in FIG. 12.

It should be noted that, until the transport member 31 is once moved to its full stroke in the direction of arrow A, that is, until the second gear part 43b of the movement producing gear 43 forming the first driving unit 33 is moved from the first linear part 47a to the curved part 47b of the rack gear 47, the slider 51 is prohibited from performing the sliding movement along the guide groove 58.

If, after the transport member 31 is once moved to its full stroke in the direction of arrow A, the transport member 31 commences its movement in the direction opposite to that indicated by arrow A, the second gear part 43b of the movement producing gear 43 reaches the curved part 47b of the rack gear 47, such that the sector gear 42, carrying the movement producing gear 43, is rotated in the direction opposite to that indicated by arrow B in FIG. 7, about the first support shaft 41a as center. This causes rotation of the cam gear 44, so far meshing with the arcuate gear 42b. The operating pin 45a of the operating lever 45 is moved from the inner rim side end to the outer rim side end of the cam groove 44c of the cam gear 44, whilst the operating lever 45 is moved in the direction opposite to that indicated by arrow C in FIG. 7. The distal end of the operating lever 45 is engaged via cut-out 58c in the guide groove 58 in the engagement recess 51c in the slider 51, while thrusting the thrust part 52b of the regulating member 52. This causes rotation of the regulating member 52, in the direction opposite to that indicated by arrow D in FIG. 7, against the bias of the torsion coil spring 59, with the support shaft 51d as center, to release the lock of the lock part 52c in the lock opening 58a. In this manner, the slider 51 is may be slid along the guide groove 58 in the direction indicated by arrow A and in the direction opposite to that indicated by arrow A.

When the second gear part 43b of the movement producing gear 43 of the first driving unit 33 has reached the second linear part 47c of the rack gear 47, and the transport member 31 is moved in the direction opposite to that indicated by arrow A, the slider 51 of the second driving unit 106 is slid in the direction indicated by arrow A within the guide groove 58, relative to the transport member 31, by the distal end of the operating lever 45, mounted on the guide member 32, engaging in the engagement recess 51b. This causes rotation of the first transmission gear 53, meshing with the rack gear 51a of the slider 51 via the opening 58b in the guide groove 58, such that, via second to seventh transmission gears 54 to 109, the eighth transmission gear 113 is rotated in unison with the seventh transmission gear 109, as shown in FIG. 15. As the rotational gear 114, meshing with the rotation producing gear 113c, is rotated, the stocker 103 is rotated, over an angular extent of approximately 90°, in the direction indicated by arrow F, by the meshing of the rotational gear 114 and the rack gear 119, from the state shown in FIG. 22 to that shown in FIG. 23. In this manner, the stocker 103 is in such a state in which the disc insertion/ejection openings 153 of the disc housing components 102a to 102f are directed upwards and in which the major surfaces of the disc housing components 102a to 102f are oriented in a direction substantially perpendicular to the transport direction of the stocker 103.

When the eighth transmission gear 113 is rotated in unison with the seventh transmission gear 109, the second and fourth disc housing components 102b, 102d, as counted from the bottom, are slid in opposite directions to each other, about the first pinion 113d, mounted to the third disc housing component 102c, as counted from the bottom, as the first pinion 113d is rotated. The lowermost disc housing component 102a is then slid in the same direction as the second disc housing component 102b, as counted from the bottom, relative to the third disc housing component 102c, as counted from the bottom, about the second pinion 123, mounted to the second disc housing component 102b, as counted from the bottom, and which is slid in one direction. The fifth disc housing component 102e as counted from the bottom is then slid in the same direction as the fourth disc housing component 102d, as counted from the bottom, relative to the third disc housing component 102c, as counted from the bottom, about the third pinion 127, mounted to the fourth disc housing component 102d, as counted from the bottom, and which is slid in the other direction. In this manner, the disc housing components 102a to 102e are progressively offset in the up-and-down direction, from the state shown in FIG. 24 to the state shown in FIG. 25.

Thus, when transported to the pull-out position outside the main body unit 101, by the stocker transport mechanism 104, the stocker 103 transfers from the substantially upstanding position to the state in which the disc housing components 102a to 102e are progressively offset in the up-and-down direction, as shown in FIGS. 12 and 14. In this manner, the optical disc 1 may be exchanged readily, as the outer rim of the optical disc 1 is gripped, while the optical discs 1 may be exchanged readily with respect to the disc housing components 102a to 102f.

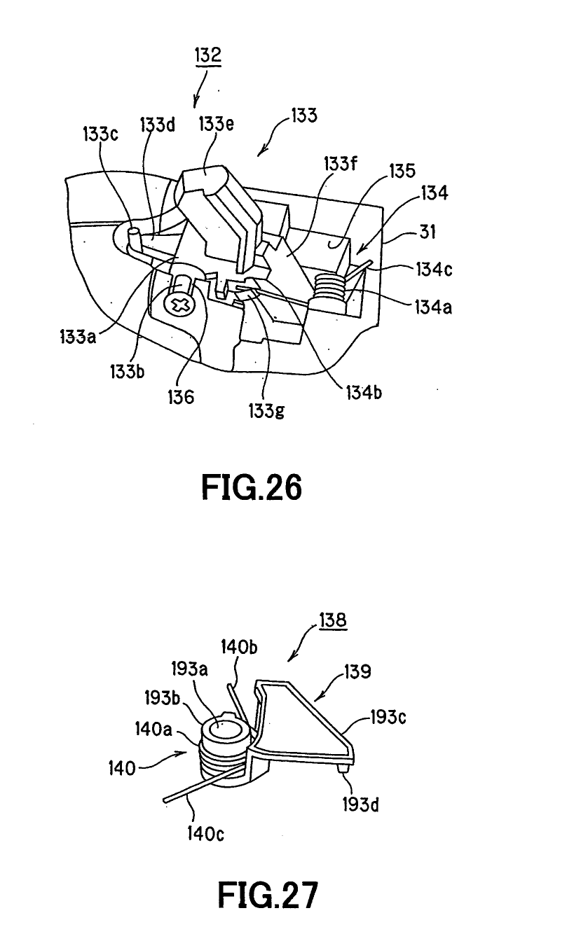

The stocker transport mechanism 104 includes a rotation lock mechanism 132 for prohibiting rotation of the stocker 103 when the stocker 103 is in the pullout position. Specifically, the rotation lock mechanism 132 includes a lock member 133, rotationally mounted in the vicinity of the sixth and seventh transmission gears 108, 109 of the transport member 31, and a torsion coil spring 134 for biasing the lock member 133 in one rotational direction, as shown in FIG. 26.

The lock member 133 includes a base 133a, and a pair of support shafts 133b, protruded from both sides of the base 133a. The lock member 133 is supported for rotation between first and second positions, by the base 133a being held within a hold opening 135 formed in the transport member 31 and by the support shafts 133b being carried by a bearing 136 provided to the transport member 31.

The lock member 133 includes a first arm 133d, protruded from the base 133a, and which is provided at the distal end thereof with a thrust pin 133c thrust against rib 109g of the seventh transmission gear 109. When the lock member 133 is in the first position, the thrust pin 133c at the distal end of the first arm 133d is protruded to the opposite surface of the transport member 31 from the hold opening 135. When the lock member 133 is in the second position, the thrust pin 133c is housed in the hold opening 135.

The lock member 133 also includes a second arm 133e, protruded from the base 133a, and which is thrust against rib 108i of the sixth transmission gear 108. When the lock member 133 is in the first position, the second arm 133e is protruded substantially at right angles to one surface side of the transport member 31 and, when the lock member 133 is in the second position, the second arm 133e falls obliquely down towards the first arm 133d.

The lock member 133 also includes a lock part 133f protruded from the base 133a and which may be abutted against the back side of the lowermost disc housing component 102a. When the lock member 133 is in the first position, the lock part 133f is protruded substantially vertically from the hold opening 135 towards one side of the transport member 31. When the lock member 133 is in the second position, the lock part 133f falls down and is housed within the hold opening 135.

A support shaft 137, located in the hold opening 135 of the transport member 31, is introduced into the inside of a coiled part 134a of the torsion coil spring 134. In this state, the torsion coil spring 134 has its one end 134b retained by a retention piece 133g, provided to one lateral surface of the base 133a, while having its other end retained by the opening end of the hold opening 135, for biasing the lock member 133 towards the first position.

With the above-described rotation lock mechanism 132, when the stocker 103 is in the housed position within the main body unit 101, as shown in FIG. 15, the thrust pin 133c of the first arm 133d is thrust against the rib 109g of the seventh transmission gear 109, and hence the lock member 133 is in the second position, against the bias of the torsion coil spring 134. Since the lock part 133f of the lock member 133 falls down into and is housed in this state in the hold opening 135, the locked state of the stocker 103 has already been released.

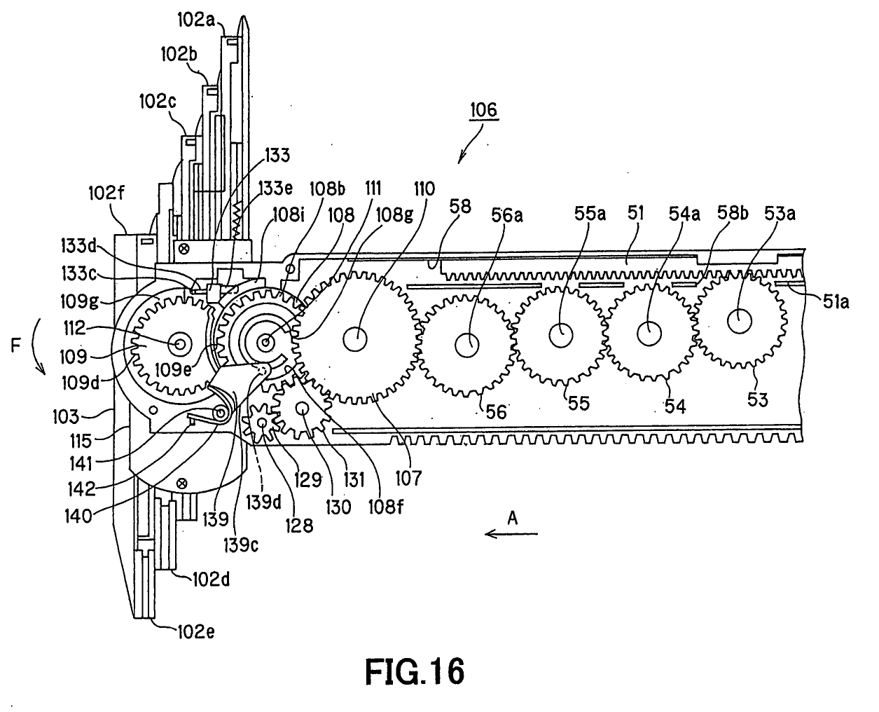

If the stocker 103 has been pulled out of the main body unit 101, as shown in FIG. 16, the second gear part 43b of the movement producing gear 43 being then rotated and the slider 51 being slid in the direction indicated by arrow A, the stocker 103 is rotated in the direction indicated by arrow F and set substantially upright, the second arm 133e of the lock member 133 being then thrust against the rib 108i of the sixth transmission gear 108. At this time, the lock member 133 is in the second position, against the bias of the torsion coil spring 134. Hence, the lock part 133f of the lock member 133 falls down into and housed in this state within the hold opening 135, the locked state with respect to the stocker 103 remains released.

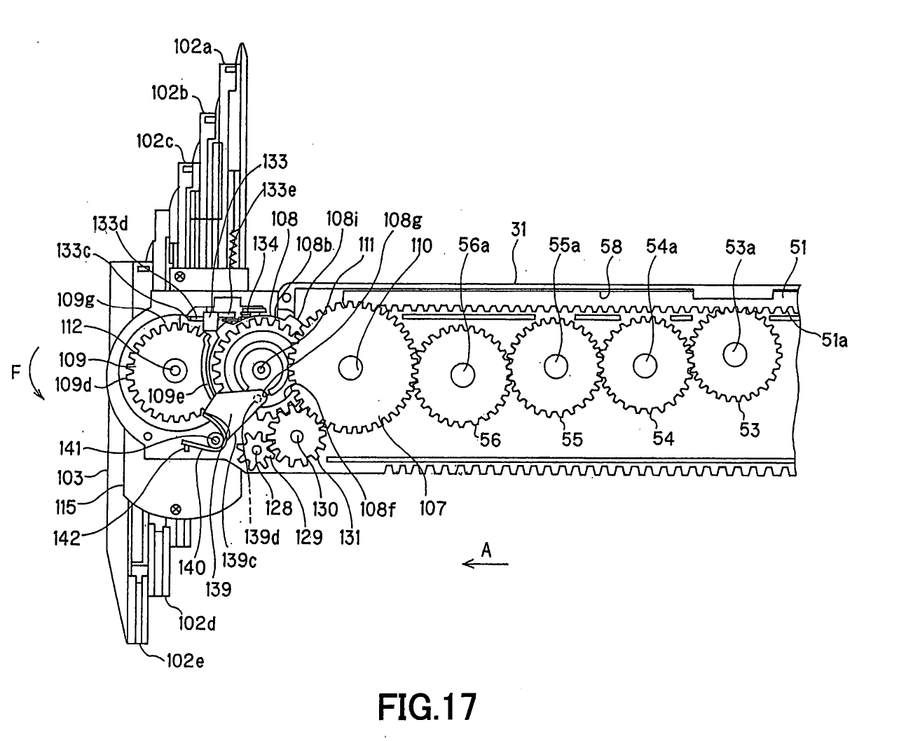

If the stocker 103 is then transported to the pullout position outside the main body unit 101, as shown in FIG. 17, the second gear part 43b of the movement producing gear 43 is further rotated and the slider is slid in the direction indicated by arrow A. The state of meshing of the second gear part 108c of the sixth transmission gear 108 with the gear part 109b of the seventh transmission gear 109 is now released, with the guide wall section 108h of the sixth transmission gear 108 then sliding within the guide groove 109e of the seventh transmission gear 109. Thus, the seventh transmission gear 109 is not rotated, only the sixth transmission gear 108 being rotated, such that, ultimately, the second arm 133e ceases to be thrust by the rib 108i of the sixth transmission gear 108. The lock member 133 is then rotated up to the first position, under the bias of the torsion coil spring 134, with the lock part 133f of the lock member 133 being then protruded from the hold opening 135 substantially vertically towards one side of the transport member 31 into abutment with the back side of the lowermost disc housing component 102a in the stocker 103.

In this manner, if, with the present rotation lock mechanism 132, the stocker 103 is in the pullout position, the rotation of the stocker 103 in the direction opposite to that indicated by arrow A may be prohibited, and hence the stocker 103 may be kept in the substantially upstanding state.

If conversely the stocker 103 in this pullout position is to be transported into the housed position in the main body unit 101, the driving gear 41 is rotated in reverse, thereby causing movement of the second gear part 43b of the movement producing gear 43 from the first linear part 47a towards the curved part 47b of the rack gear 47. During the time the second gear part 43b is moved along the second linear part 47c towards the curved part 47b of the rack gear 47, the transport member 31 is moved in the direction indicated by arrow A. The slider 51 is slid at this time in the direction opposite to that indicated by arrow A. Then, by the operation opposite to that proceeding from the state shown in FIGS. 22 and 24 to that shown in FIGS. 23 and 25, that is, by the operation proceeding from the state shown in FIGS. 23 and 25 to that shown in FIGS. 22 and 24, the stocker 103 is in such a state in which the disc insertion/ejection openings 153 of the disc housing components 102a to 102f are within the main body unit 101 and in which the major surfaces of the disc housing components 102a to 102f are oriented in a direction substantially parallel to the transport direction of the stocker 103.

When the second gear part 43b has reached the curved part 47b of the rack gear 47 to proceed towards the first linear part 47a, the sector gear 42, having fixedly mounted thereon the movement producing gear 43, is rotated in the direction opposite to that indicated by arrow B in FIG. 6, about the first support shaft 41a as center. This causes rotation of the cam gear 44, meshing with the arcuate gear 42b, so that the operating pin 45a of the operating lever 45 is moved from the outer rim side end to the inner rim side end of the cam groove 44c of the cam gear 44. The operating lever 45 is then moved in the direction opposite to that indicated by arrow C in FIG. 6. This causes the distal end of the operating lever 45 to be receded from the engagement recess 51c of the slider 51, via cut-out 58c formed in the guide groove 58. The regulating member 52 is rotated in the direction indicated by arrow D in FIG. 6, under the bias of the torsion coil spring 59, about the support shaft 51d, to produce the locked state of the lock part 52c in the lock opening 58a, with the slider 51 then being prohibited from performing slide movement. During the time until the second gear part 43b of the movement producing gear 43 reaches the distal end of the first linear part 47a of the rack gear 47, the transport member 31 proceeds in the direction opposite to that indicated by arrow A to pull the stocker 12 mounted to the transport member 31 into the inside of the main body unit 11.

Meanwhile, the stocker transport mechanism 104 includes a thrusting unit 138 for thrusting the stocker 103, rotated up to the end in the direction opposite to that indicated by arrow F, in the same direction opposite to that indicated by arrow F, when the stocker 104 has been transported up to the housing position.

This thrusting unit 138 includes a thrusting member 139, rotationally mounted to the transport member 31, and a torsion coil spring 140, operating as biasing means for biasing the thrusting member 139 in one rotational direction, as shown in FIGS. 15 and 27.

The thrusting member 139 includes a sleeve 139b, formed with a shaft opening 139a, an engagement member 139c, engaged in the cut-out 108g of the sixth transmission gear 108 and a guide pin 139d on a surface of the engagement member 139c facing the sixth transmission gear 108. This thrusting member 139 is mounted in position by the passage through the shaft opening 139a of the support shaft 141 provided to the opposite surface of the transport member 31 and by the engagement of the guide pin 139d of the engagement member 139c in the guide groove 108f of the sixth transmission gear 108.

The torsion coil spring 140 biases the lock member 133 in a direction of abutting the guide pin 139d of the engagement member 139c against the inner rim side wall section 108e of the guide groove 108f, by retention of one end 140b of the torsion coil spring 140 between the sleeve 139b and the engagement member 139c, with the sleeve 139b and the engagement member 139c being introduced into the coiled part 134a of the torsion coil spring 140, and by engagement of the guide pin 139d of the engagement member 139c in the guide groove 108f of the sixth transmission gear 108.

With the above-described thrusting unit 138, the thrusting member 139 thrusts the sixth transmission gear 108 in one direction, under the bias of the torsion coil spring 134, by transfer from the state in which the guide pin 139d of the thrusting member 139 is slid within the guide groove 108f of the sixth transmission gear 108 to the state in which, as shown in FIG. 15, the engagement member 139c of the thrusting member 139 is engaged in the cut-out 108g of the sixth transmission gear 108, which transfer is caused by rotation of the sixth transmission gear 108, as shown in FIGS. 16 and 17. This sets the second driving unit 106 to such a state in which the respective transmission gears are offset towards one side of the rotational direction so as to take up the backlash of the respective gears.

Thus, with the present thrusting unit 138, when the stocker 103 is in the housed position in the main body unit 101, such a state may be maintained in which the disc insertion/ejection openings 153 of the disc housing components 102a to 102f are within the main body unit 101 and in which the major surfaces of the disc housing components 102a to 102f are oriented in a direction substantially parallel to the transport direction of the stocker 103.

With the stocker transport mechanism 104, the operation of transporting the stocker 53 from its pullout position to its housed position is initiated by pushing or pulling the stocker 103 when the stocker 53 is in the pullout position.

Specifically, the main body unit 101 is provided with a forward side first detection switch 143a and a rear side second detection switch 143b, forming a pair, for detecting the position of the transport member 31, adapted for transporting the stocker 103, as shown in FIG. 10. Of these, the forward first detection switch 143a is thrust by the transport member 31 when the stocker 103 is in the pullout position. When this forward side first detection switch 143a is thrust, the stocker transport mechanism 104 halts the transport operation for the stocker 103. The rear side second detection switch 143b is thrust by the transport member 31, which is slid in the direction opposite to that indicated by arrow A when the user thrusts the stocker 103 which is in the pullout position. When this rear side second detection switch 143b is thrust, the stocker transport mechanism 104 commences the operation of transporting the stocker 103 from the pullout position to the housed position. The stocker transport mechanism 104 also commences the operation of transporting the stocker 103 from the pullout position to the housed position when the thrusting of the first detection switch 143a by the transport member 31, slid in the direction indicated by arrow A, is annulled, by the user pulling the stocker 103 which is in the pull-out position.

With the present disc changer apparatus, the operation of transporting the stocker from the pullout position to the housed position may be commenced by the user's operation for pulling or pushing the stocker 103 when the stocker 53 is in the pullout position. On the front side of the stocker 103, there is mounted a guard member 144 for interconnecting the paired transport members 31. The pull-in operation for the stocker 103 may readily be commenced by the user pulling or pushing the guard member 144.

The specified structure of the stocker 103 is now explained in detail.

The disc housing components 102a to 102f, making up the stocker 103, are substantially of the same structure, except the stacking order or the difference as to whether the optical disc 1 housed is the 12 cm optical disc or the 8 cm optical disc. Hence, these disc housing components 102a to 102f are sometimes referred to below collectively as the disc housing component 102.

Referring to FIGS. 13 and 14, the stocker 103 is provided with five disc housing components 102a to 102e for housing optical discs 1 of standard size, that is, a diameter of 12 cm, and a disc housing component 102f, dedicated to a small-sized disc, that is, an optical disc 1a of a diameter of 8 cm, smaller than the standard size disc. The disc housing components 102a to 102f are stacked together so that the disc housing component 102f is located in the uppermost layer.

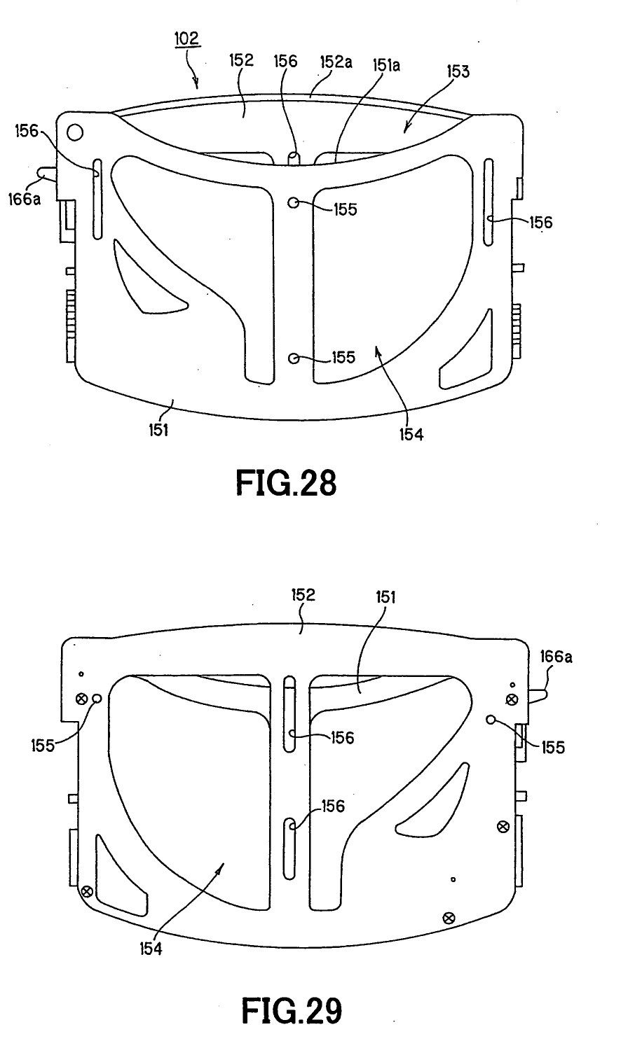

Referring to FIGS. 28 and 29, the disc housing component 102 includes a pair of disc halves 151, 152, abutted together. By abutting the disc halves 151, 152 together, there are defined a disc insertion/ejection opening 153 for insertion/ejection of the optical disc 1 and a housing pocket 154 into which the optical disc 1 is introduced via disc insertion/ejection opening 153.

Referring to FIG. 14, the disc insertion/ejection opening 153 is formed in lateral sides 151a, 152b of the paired disc halves 151, 152. Of these, the lateral side of the front side half 151a, with the disc insertion/ejection openings 153 of the disc housing components 102a to 102f sequentially offset in the insertion/ejection direction of the optical disc 1, is more recessed in the direction of insertion of the optical disc 1 than the lateral side of the back side half 151a. In this manner, the user may readily exchange the optical disc 1 for the disc housing components 102a to 102f in a state in which the disc housing components 102a to 102e are offset in the up-and-down direction.

In addition, the surfaces of the rear side half 152, forming the housing pockets 154, with the disc insertion/ejection openings 153 of the disc housing components 102a to 102f, directed to the proximal side, with the disc housing components being sequentially offset in the insertion/ejection direction for the optical disc 1, are supplied with coating films of differentiated colors, for facilitated exchange of the optical discs 1 by the user and for sliding the disc housing component 102 in the stocker 103.

As a mistaken insertion prohibiting means for preventing the optical disc 1 from being inserted into a gap between the neighboring disc housing components 102, a retention lug 155 for prohibiting movement in the inserting direction of the optical disc 1 into the gap is formed in one of the disc housing components 102 forming the gap and a through-hole 156 for clearing the lug 155 is formed on a surface of the counterpart disc housing component 102 forming the gap. A pair of the retention lugs 155 are arranged on the mid part of the front side half 151, and another pair of the retention lugs 156 are arranged on both sides of the mid part of the back side half 152. In a corresponding fashion, a pair of the through-holes 156 are formed as oblong holes extending along the direction of insertion/ejection of the optical disc 1, whilst another pair of the through-holes 156 are formed on both sides of the mid part of the front side half 151.

Hence, if the user, intending to exchange the optical discs 1, tries to insert the optical disc 1 into the gap defined between neighboring disc housing components 102, the optical disc 1 is prevented from movement in the inserting direction, by these retention lugs 155, so that it becomes possible to prevent the optical disc 1 from being inadvertently introduced into the above gap.

Referring to FIG. 13, the disc housing components 102a to 102e for housing the optical disc 1 of 12 cm in diameter are each provided with a disc ejection opening 157 for ejecting the optical disc 1a to outside from a location different from the disc insertion/ejection opening 153. This disc ejection opening 157 is provided on the opposite side of the disc insertion/ejection opening 153, that is, from a bottom part, of the disc housing component 102.

Thus, in the upstanding state of the stocker 103, the small-sized optical disc 1, inadvertently introduced into the disc insertion/ejection opening 153, may be compulsorily ejected from the disc ejection opening 157 to outside the housing pocket 154.

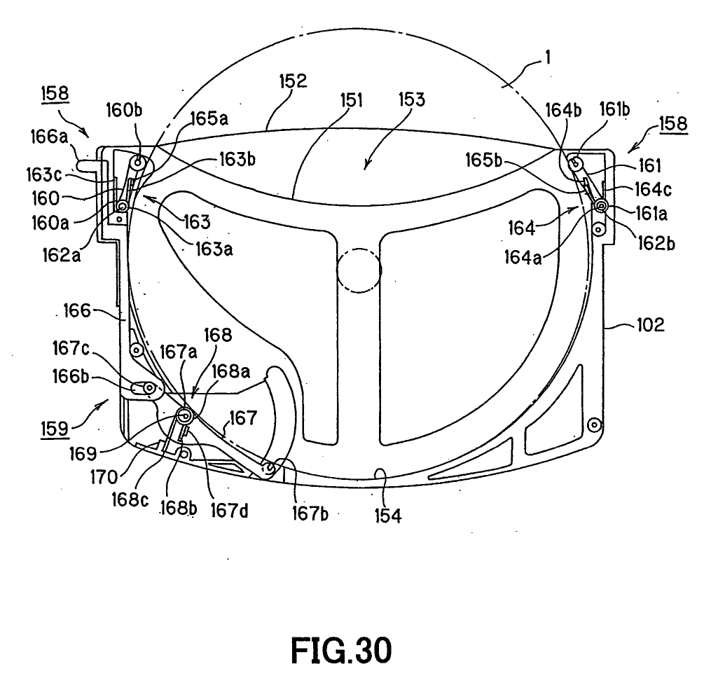

Referring to FIGS. 30 to 32, the disc housing component 102 is provided with a disc insertion/ejection assisting unit 158, when the optical discs are inserted into and ejected from the disc housing component 102, and with a disc extrusion unit 159, for extruding the optical disc 1, housed in the disc housing component 102, via disc insertion/ejection opening 153 to outside the disc housing component.

The disc insertion/ejection assisting unit 158 includes a first rotational arm 160 and a second rotational arm 161, arranged on both sides of the optical disc 1, placed in-between. These rotational arms 160, 161 rotationally supported by the insertion of the support shafts 162a, 162b formed on the inner surfaces of the front side half 151 through shaft openings 160a, 161b formed on the proximal ends. The optical disc 1 is inserted into and ejected from the disc insertion/ejection opening 153 of the disc housing component 102. To the distal ends of the first rotational arm 160 and the second rotational arm 161 are rotationally mounted a first abutment roll 160b and a second abutment roll 161b abutted against the outer rim of the optical disc 1 inserted into or ejected via the disc insertion/ejection opening 153. The proximal ends of the first rotational arm 160 and the second rotational arm 161 are located closer to the disc insertion/ejection opening 153 than are the distal ends thereof, which may be oscillated in a direction towards and away from each other within a plane parallel to the major surface of the optical disc 1 inserted via the disc insertion/ejection opening 153.

The disc insertion/ejection assisting unit 158 includes a first torsion coil spring 163 and a second torsion coil spring 164, operating as biasing members for biasing the first rotational arm 160 and the second rotational arm 161 towards each other. These first and second torsion coil springs 163, 164 bias the first rotational arm 160 and the second rotational arm 161 in a direction towards each other, as the support shafts 162a, 162b are passed through the wound parts 163a, 164a of the torsion coil springs, by retention of ends 163a, 164b and the opposite sides thereof by retainers 165a, 165b provided to the inner surface of the front surface side half 151 and by the sidewall section of the disc housing component 102.

With the above-described disc insertion/ejection assisting unit 158, the outer rim of the optical disc 1 is clamped between the first abutment roll 160b and the second abutment roll 161b. These rotational arms 160, 161 rotationally supported by the first abutment roll 160b and the second abutment roll 161b and, when the disc center is on the opposite side of the disc insertion/ejection opening 153 with respect to a straight line interconnecting the first abutment roll 160b and the second abutment roll 161b, the optical disc is thrust in the disc inserting direction by the biasing force of the first torsion coil spring 163 and the second torsion coil spring 164, whereas, when the disc center is towards the disc insertion/ejection opening 153 with respect to the straight line interconnecting the first abutment roll 160b and the second abutment roll 161b, the optical disc is thrust in the disc ejecting direction by the biasing force of the first torsion coil spring 163 and the second torsion coil spring 164.

Hence, with the present disc insertion/ejection assisting unit 158, the optical disc 1 may be biased in the disc inserting direction and in the disc ejecting direction, during the time of insertion and ejection of the optical disc 1, respectively, in conjunction with the operation of inserting and ejecting the optical disc 1 for the disc housing component 102.

The disc extrusion unit 159 includes an operating member 166, facing to outside from one lateral side of the disc housing component 102, and which may be slid in the direction of inserting or ejecting the optical disc 1, an extruding member 167, and a torsion coil spring 168, operating as a biasing means for locating the operating member 166 on the side of inserting the optical disc 1 during non-housing of the optical disc 1. The extruding member is abutted against the outer rim opposite to the disc insertion/ejection opening 153 of the optical disc 1 housed within the disc housing component 102, and may be rotated in the direction opposite to the disc insertion/ejection opening 153 of the optical disc 1 housed within the disc housing component 102.

The operating member 166 is an elongated flat plate member arranged along one inner lateral side of the disc housing component 102, and includes an operating lever 166a on one longitudinal end thereof protruded to outside via an opening formed in one lateral surface of the disc housing component 102, while including an elongated opening 166b on the other longitudinal end thereof.

The extruding member 167 is an elongated flat plate member rotationally supported in a plane parallel to the major surface of the optical disc 1, inserted via the disc insertion/ejection opening 153, by insertion of a support shaft 169, provided to the inner surface of the front side half 151, in a shaft opening 167a formed between one and the other ends thereof. To one end of the extruding member 167 is rotationally mounted an abutment roll 167b abutted against the outer rim of the optical disc 1 introduced via the disc insertion/ejection opening 153. To the opposite end of the extruding member 167 is mounted a guide pin 167c engaged in the elongated opening 166b of the operating member 166.

The torsion coil spring 168 biases the extruding member 167 in one rotational direction, so that the abutment roll 167b of the extruding member 167 is located on the side of inserting the optical disc 1, with the support shaft 169 having been inserted into the coiled part 168a, by having one end 168b of the torsion coil spring retained by a retainer 167d of the extruding member 167 and by having its opposite end 168c retained by a retainer 170 provided on the inner surface of the front side half 151.

Thus, the state of this disc extrusion unit 159 in the non-housing state of the optical disc 1 is such that, under the bias force of the torsion coil spring 168, the abutment roll 167b of the extruding member 167 has been rotated in the direction of ejecting the optical disc 1, whilst the operating lever 166a of the operating member 166 has been slid in the direction of inserting the optical disc 1. Conversely, the state of this disc extrusion unit 159 in the housing state of the optical disc 1 is such that, against the bias force of the torsion coil spring 168, the abutment roll 167b of the extruding member 167 has been rotated in the direction of inserting the optical disc 1, whilst the operating lever 166a of the operating member 166 has been slid in the direction of ejecting the optical disc 1.

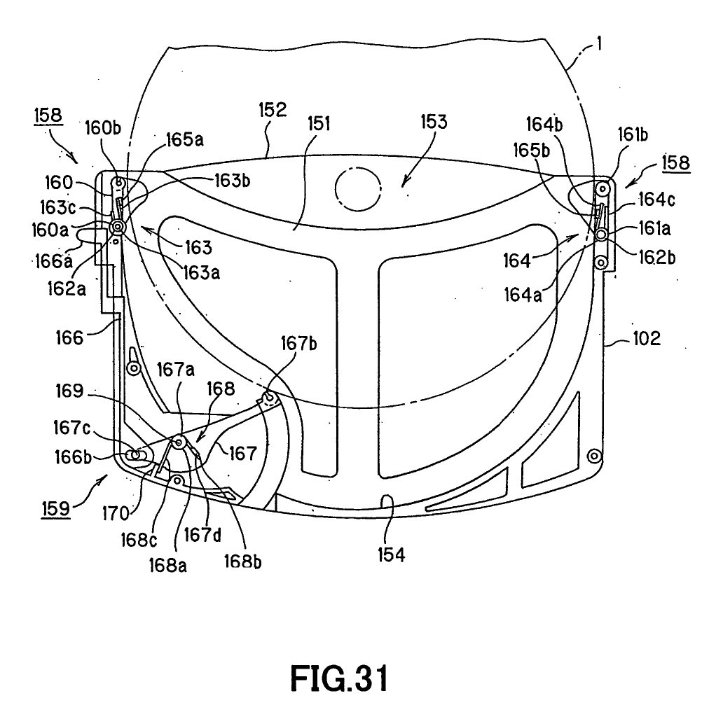

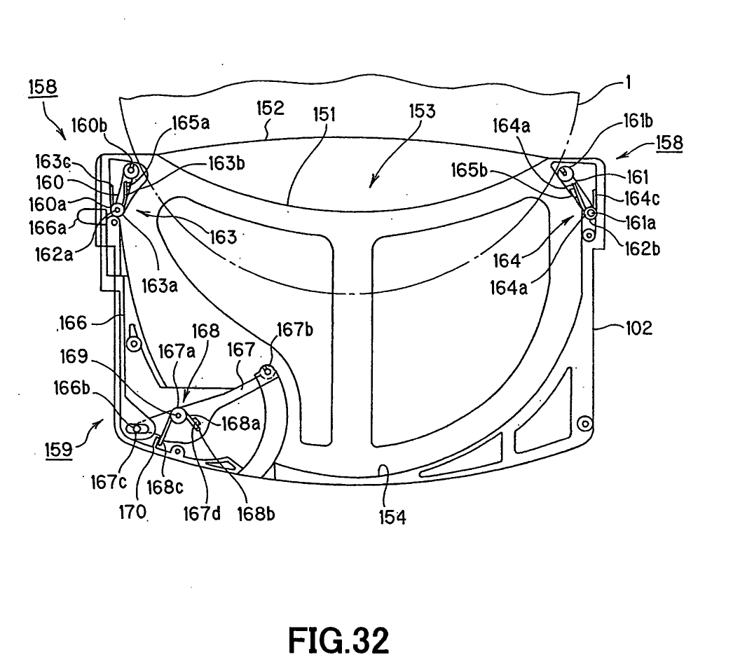

With the above-described disc housing component 102, the abutment roll 167b of the extruding member 167 extrudes the optical disc 1, housed in the housing pocket 154, via disc insertion/ejection opening 153, as the abutment roll 167b of the extruding member 167 is rotated in the direction of ejecting the optical disc 1, as shown in FIG. 31, by sliding the operating lever 166a of the operating member 166 in the direction of inserting the optical disc 1, (see FIG. 30). Since the disc insertion/ejection assisting unit 158 biases the optical disc 1 in the disc ejecting direction, the optical disc 1 may be reliably ejected from the disc insertion/ejection opening 153, as shown in FIG. 32. On the other hand, since the optical disc 1 may be extruded from the disc housing component 102, by the above-described sliding operation of the operating lever 166a, the optical disc 1, housed in the disc housing component 102, may be exchanged extremely readily.

If the optical disc 1 is inserted via the disc insertion/ejection opening 153, as shown in FIG. 32, the abutment roll 167b of the extruding member 167 is rotated in the direction of inserting the optical disc 1, as the abutment roll abuts on the outer rim of the optical disc 1, at the same time that the operating lever 166a of the operating member 166 is slid in the direction of introducing the optical disc 1, as shown in FIG. 31. The disc insertion/ejection assisting unit 158 acts for biasing the optical disc 1 in the introducing direction, the optical disc 1 may be reliably housed in the housing pocket 154, from the disc insertion/ejection opening 153, and maintained in this housed state, as shown in FIG. 30.

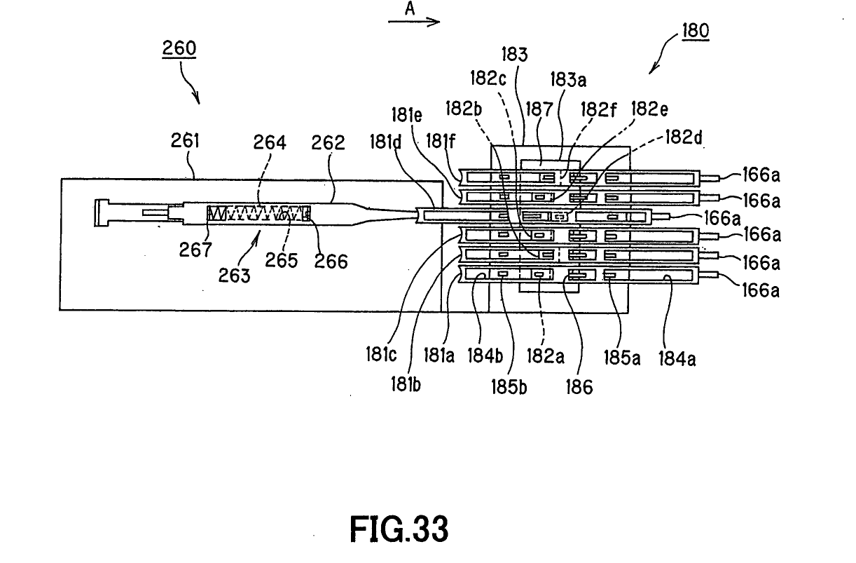

On one lateral side of the main body unit 101, there is provided a disc presence/absence detection unit 180 for detecting the presence or absence of the optical disc 1 in the disc housing components 102a to 102f when the stocker 103 has been transferred from the pullout position to the housed position, as shown in FIG. 33.

A plural number of the disc presence/absence detection units 180 are provided in juxtaposition, in association with the operating levers 166a facing outwards from one lateral sides of the disc housing components 102a to 102f of the stocker 103, and are provided with slide levers 181a to 181f, slidable in the transporting direction for the stocker 103, and with a plural number of detection switches 182a to 182f, for detecting the positions of the slide levers 181a to 181f, respectively.

The slide levers 181a to 181f are slidably carried by a frame 183 provided to one lateral surface of the main body unit 101. Specifically, these slide levers 181a to 181f are each formed with a forward guide slit 184a and a rear guide slit 184b, forming a pair. The guide slits 184a, 184b are carried for sliding along the transport direction of the stocker 103, by engagement in these guide slits of a forward anti-extraction pin 185a and a rear anti-extraction pin 185b, provided on the frame 183, and together forming a pair. Between the guide slits 184a and 184b of the slide levers 181a to 181f are formed lugs 186 protruded from the major surface opposite to the major surface facing the frame 183.

The detection switches 182a to 182f are mounted side-by-side in an alternating fashion on a circuit substrate 187. This circuit substrate 187 is mounted on the major surface of the frame 187 opposite to the mounting surface thereof for the slide levers 181a to 181f, so that the detection switches 182a to 182f face the slide levers 181a to 181f via opening 183a formed in the frame 183.

With the above-described disc presence/absence detection unit 180, the positions of the slide levers 181a to 181f are detected by the detection switches 182a to 182f, by the sliding from the forward side to the rear side of only the slide lever abutted against the operating lever 166a of the disc housing component 102 housing the optical disc 1 when the stocker 103 has been transported from the pullout position to the housed position, for example, only the fourth slide lever 281d, as counted from the bottom side, in case the optical disc is housed within the fourth disc housing component 102d as counted from the bottom side.

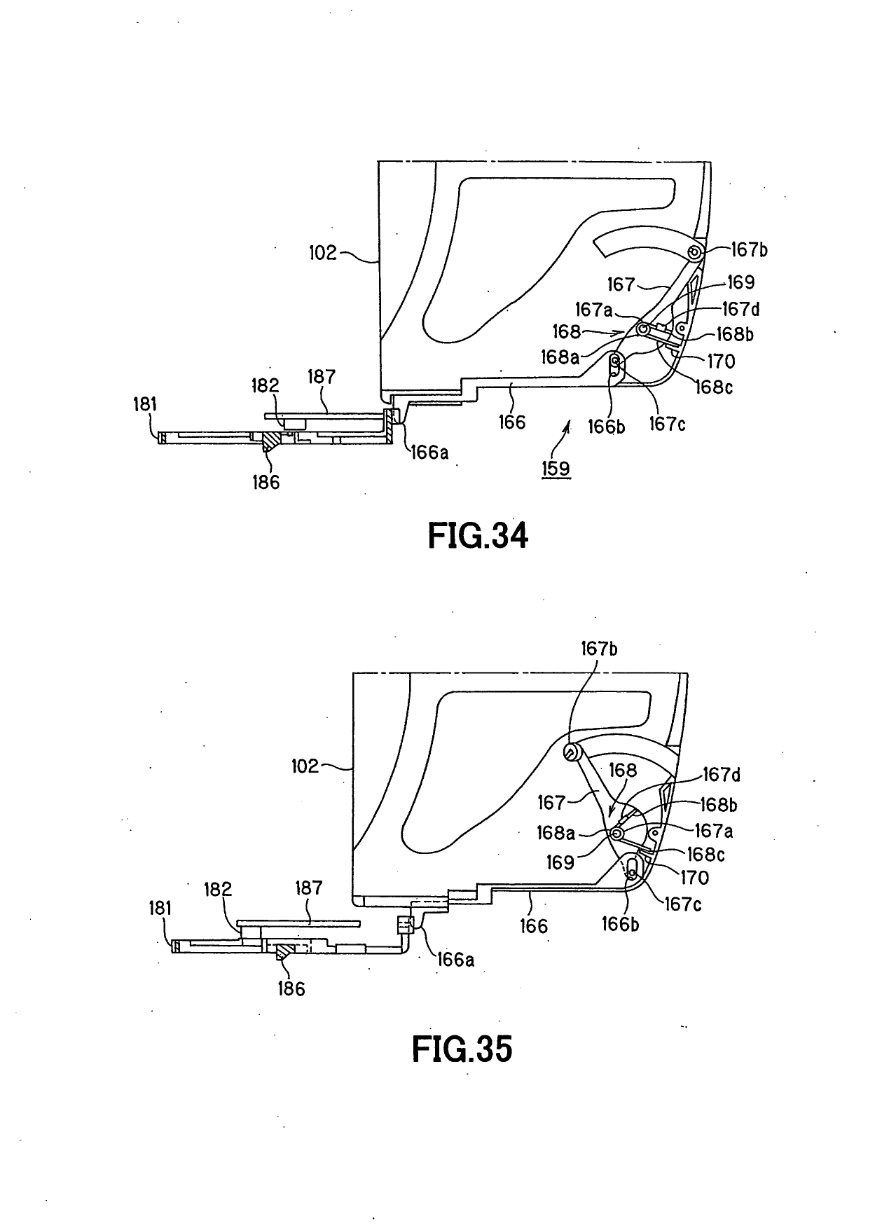

Specifically, when the optical disc 1 is housed within the disc housing component 102, the detection switch 182 is thrust by the sliding from the front surface side to the back surface side of the slide lever 281 abutted against the operating lever 166a, as shown in FIG. 34. If conversely there is no optical disc 1 housed within the disc housing component 102, the slide lever 281 is retained on the forward surface side, without thrusting the detection switch 182, as shown in FIG. 35. Thus, with the disc presence/absence detection unit 180, the presence/absence of the optical disc 1 in each of the disc housing components 102a to 102f may be detected by detecting the position of the operating lever 166a facing outwards from one lateral surface of each of the disc housing components 102a to 102f.

It is noted that, with the present disc presence/absence detection unit 180, the slide levers 181a to 181f are located on the forward surface side along the slide direction, by way of re-setting, by the transport member 31 thrusting the lugs 186 of the slide levers 181a to 181f when the stocker 103 has been transferred from the housed position to the pull-out position.

The specified structure of the main body unit 101 is now explained.

Referring to FIGS. 10, 34 and 35, there is provided, in the inside of the main body unit 101, a disc drive unit 201 configured for recording and/or reproducing a selected one of the optical discs 1 housed in the stocker 103 which is then in the housing position.

With the disc drive unit 201, the optical disc 1 is introduced via a disc inserting/ejecting opening 203, formed in a casing 202. The optical disc 1 is transported as it is guided by a disc transport unit 204 provided to a top plate 202a forming the upper surface side of the casing 202. A mechanical chassis 207, carrying a disc rotation driving unit 205 and an optical pickup 206, is mounted to a base plate 202b, forming the lower side of the casing 202, and is adapted for being uplifted/lowered by a mechanical chassis uplifting/lowering unit 208.

The disc transport unit 204 includes a driving motor 209, arranged on the side base plate 202b, a first rotation transmitting unit 210a arranged on the top plate 201a for transmitting the rotation of the driving motor 209 to the disc transport unit 204, and a second rotation transmitting unit 210b arranged on the base plate 202b. If, with the disc transport unit 204, the optical disc 1 has been introduced up to a preset location via disc inlet/outlet 302, rotation of the driving motor 209 is transmitted to a transport roll, not shown, via first and second rotation transmitting units 210a, 210b. This transport roll transports the optical disc 1 as the roll is rotated.

The disc rotation driving unit 205 includes a turntable 212, mounted as one on a support shaft of a spindle motor 211, mounted to the mechanical chassis 207. To the top plate 202a is mounted a disc chuck mechanism 213 for chucking the optical disc 1 on the turntable 212. The disc chuck mechanism 213 includes a chuck member 213a and a support arm 213b for supporting the chuck member 213a. In a chuck release position, the support arm 213b is uplifted at a preset tilt angle on the top plate 202a. In case the mechanical chassis 207 has been uplifted by the mechanical chassis uplifting/lowering unit 208, the support arm 213b is lowered in keeping therewith to chuck the optical disc 1 on the turntable 212 by the chuck member 213a. That is, with the present disc drive unit 201, the operation of chucking and unchucking the optical disc 1 is carried out in keeping with the uplifting and lowering operation of the mechanical chassis 207 by the mechanical chassis uplifting/lowering unit 208. Moreover, the mechanical chassis uplifting/lowering unit 208 performs the lift/descent operation of the mechanical chassis 207 by the motive power of the driving motor 209 transmitted via a gear change unit 214.

The optical pickup 206 includes a semiconductor laser, as a light source, an objective lens for condensing the light beam, radiated from the semiconductor laser, and a photodetector for detecting the return light beam reflected back from the optical disc 1. A light beam, radiated from the semiconductor laser, is condensed by an objective lens and illuminated on the signal recording surface of the optical disc 1. On detection of the return light beam, reflected back from the reflective film, by the photodetector, the optical pickup 206 transduces the light into electrical signals, which are then output. In this manner, signals may be recorded or reproduced for the optical disc 1.

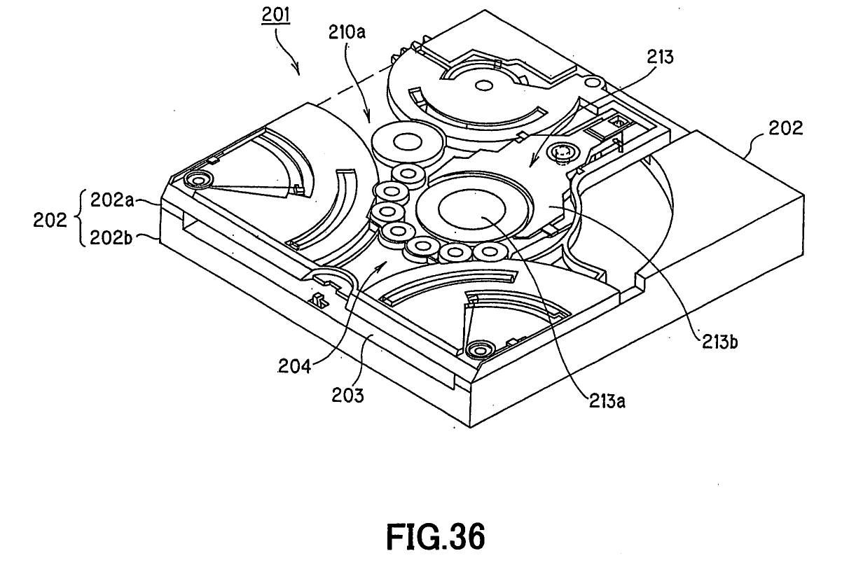

The above-described disc drive unit 201 is mounted on a base 220, shown in FIG. 36, with the side of the disc drive unit towards the disc inserting/ejecting opening 203 directed slightly upwards, in consideration of possible falldown of the optical disc 1 ejected from the disc inserting/ejecting opening 203, in order to achieve optimum transport of the optical disc 1 between the disc drive unit and the stocker 103.

The base 220, carrying the disc drive unit 201, is arranged within the main body unit 101, with the disc inserting/ejecting opening 203 thereof directed towards the stocker 103. Moreover, the base 220 may be uplifted/lowered, from one stage to another, by a base uplifting/lowering unit, not shown, so that the disc inserting/ejecting opening 203 will face the disc insertion/ejection opening 153 of the selected one of the stacked disc housing components 102a to 102f.

On the front side of the base 220, there is provided a disc transport unit 221 for transporting the 12 cm optical disc 1, housed in the disc housing components 102a to 102f, between the stocker 103 and the disc drive unit 201.

The 12 cm disc transport unit 221 includes a first slide member 222 and a second slide member 223, both slidably mounted on the major surface of the base 220. The first slide member 222 and the second slide member 223 are mounted on both sides of the base 220 on which is transported the optical disc 1. On the first slide member 222 and the second slide member 223, there are formed rack gears 222a, 223a for meshing with a pinion 224, respectively. The pinion 224 is mounted on the base 220. Thus, the first slide member 222 and the second slide member 223 are slidable in synchronism and towards or away from each other in a direction substantially perpendicular to the transport direction of the optical disc 1 by the rack gears 222a, 223a meshing with the pinion 224.

The 12 cm disc transport unit 221 also includes a torsion coil spring 225, operating as biasing means for biasing the first and second slide members 222, 223 in a direction approaching to each other. The torsion coil spring 225 has its one end retained by a retainer 226 provided to the base 220, while having its other end retained by a retainer 227 provided to the first slide member 222. In this manner, the first and second slide members 222, 223 are biased in a direction of clamping the outer rim of the optical disc 1 being transported and, as the slide members 222, 223 approach to each other, the inner sides thereof are abutted against each other.

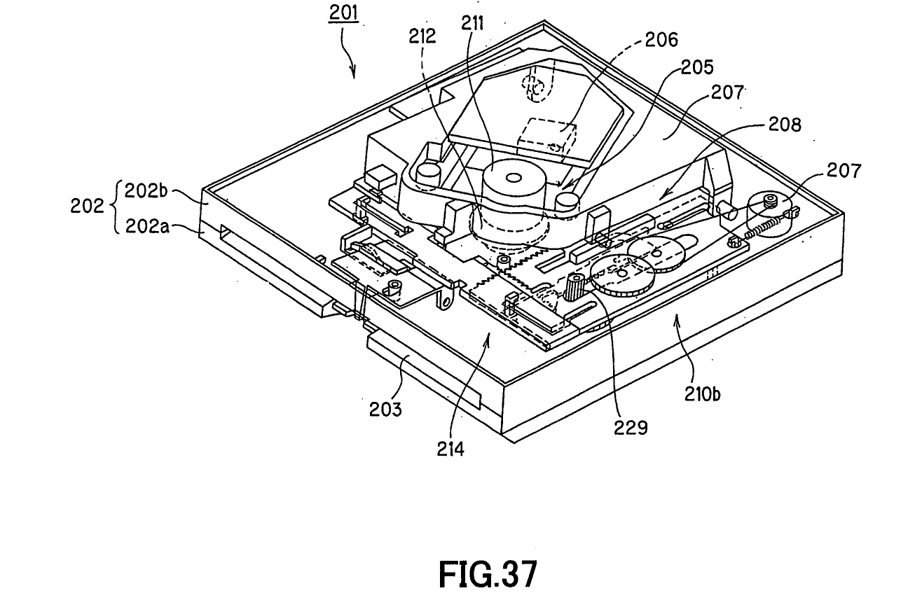

On the first slide member 222, a first feed roll 228a and a second feed roll 228b, clamping the outer rim of the optical disc 1 from one side, are rotationally mounted at the locations spaced apart from each other along the transport direction of the optical disc 1. These first and second feed rolls 228a, 228b are run in rotation in the same direction in abutting contact with the outer rim of the optical disc 1. Specifically, as a motion transmitting mechanism for transmitting the drive power from a driving motor 209 of the disc drive unit 201 to the first and second feed rolls 228a, 228b through a transmission gearing 229 forming the second rotation transmitting unit 210b shown in FIG. 37, there is provided, between the first slide member 222 and the base 220, a gear train 230 comprised of plural gears, meshing with one another, and which include a first gear, rotated in unison with the first feed roll 228a, a second gear, rotated in unison with the second feed roll 228b and a counter gear adapted for causing rotation of the first and second gears in the same direction. The first and second feed rolls 228a, 228b may be run in rotation in the same direction by the motive power of the driving motor 209 transmitted via transmission gear 229 to the gear train 230.

The second slide member 223 includes a first feed member 231 a and a second feed member 231b, both clamping the outer rim of the optical disc 1, at the locations spaced apart from each other along the transport direction for the optical disc 1. These first and second feed members 231a, 231b are stationary rolls, abutted against the outer rim of the optical disc 1. The spacing between the first and second feed members 231a, 231b is selected to be approximately equal to the spacing between the second feed member 231b and the second feed roll 228b.

With the above-described 12 cm disc transport unit 221, in which the first and second feed rolls 228a, 228b are rotated in the same direction, as the outer rim of the optical disc 1 is clamped between the first and second feed rolls 228a, 228b and the first and second feed members 231a, 231b, the selected optical disc 1 may be transported between the disc housing components 102a to 102e of the stocker 103 and the disc inserting/ejecting opening 203 of the disc drive unit 201.

Meanwhile, with the above-described 12 cm disc transport unit 221, the first and second feed members 231a, 231b may be feed rolls run in rotation in the opposite direction to that of rotation of the first and second feed rolls 228a, 228b.

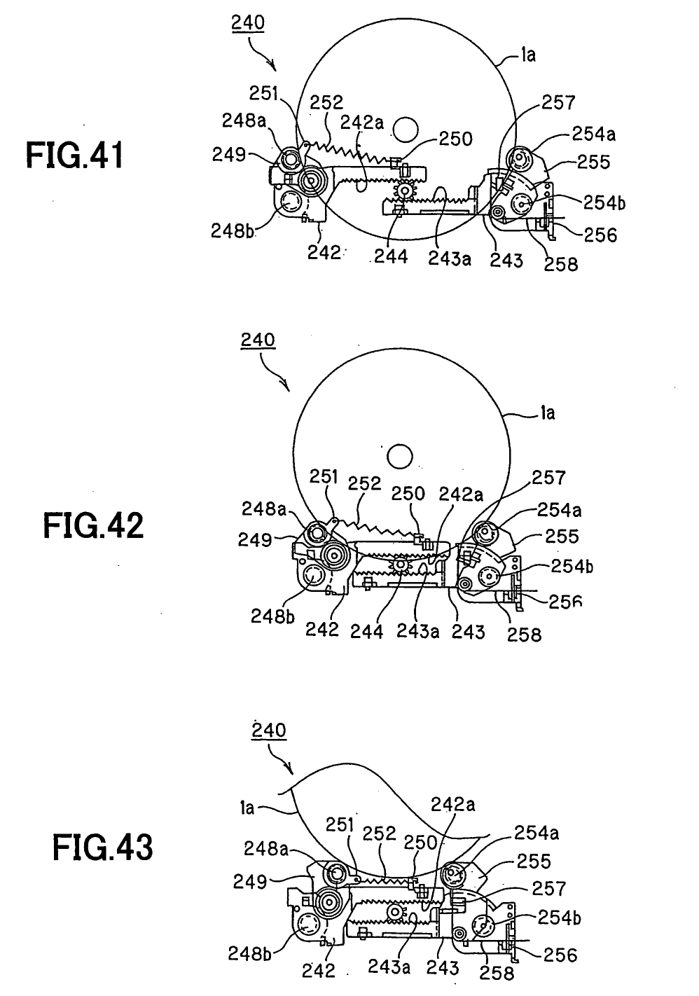

On the upper surface of the main body unit 101, as shown in FIGS. 10 and 39-43, there is provided an 8 cm disc transport unit 240 for transporting the optical disc 1a, with a diameter of 8 cm, housed within the uppermost disc housing component 102f, between the stocker 103 and the disc drive unit 201.

This 8 cm disc transport unit 240 includes a first slide member 242 and a second slide member 243, slidably mounted on the major surface of the base 241, mounted on the upper surface of the main body unit 101. These first and second slide members 242, 243 are mounted on the opposite sides of the optical disc 1a transported on the base 241. The first and second slide members 242, 243 are formed with rack gears 242a, 243a, respectively, on both sides of the pinion 244 mounted in position on the base 241 for meshing with the rack gears 242a, 243a. Hence, the first slide member 242 and the second slide member 243 may be slid in synchronism with each other, in a direction towards or away from each other, by the pinion 244 meshing with the rack gears 242a, 243a, as described above.

The 8 cm disc transport unit 240 includes a tension coil spring 245, operating as biasing means for biasing the first and second slide members 242, 243 in a direction approaching towards each other. The tension coil spring 245 has its one end retained by a retainer 246 provided to the base 241, while having its other end retained by a retainer 247 provided to the second slide member 243. In this manner, the first and second slide members 242, 243 are biased in a direction of clamping the outer rim of the optical disc 1 being transported and, as the slide members 242, 243 approach to each other, the inner sides thereof are abutted against each other.

On the first slide member 242, a first feed roll 248a and a second feed roll 248b, clamping the outer rim of the optical disc 1 from one side, are rotationally mounted at the locations spaced apart from each other along the transport direction of the optical disc 1. Of these rolls, the first feed roll 248a is rotationally mounted to the distal end of a first rotational member 249. This first rotational member 249 has its proximal end rotationally supported by the second slide member 242 and hence is movable in a direction such that the first feed roll 248a approaches to or is receded away from the outer rim of the optical disc 1a. The second feed roll 248b is mounted for rotation to the first slide member 242.

The first transport unit includes a tension coil spring 252, as a first biasing member, having one end retained by a retainer 250 provided to the first slide member 242 and having the other end retained by a retainer 251 provided to the first rotational member 249. The first rotational member 249 is biased by this tension coil spring 252 in a direction of approaching to the outer rim of the optical disc 1a.

The first feed roll 248a and the second feed roll 248b are rotated in the same direction as these rolls abut against the outer rim of the optical disc 1a. Specifically, as a motion transmitting mechanism for transmitting the drive power from the driving motor 209 of the disc drive unit 201 to the first and second feed rolls 248a, 248b through a transmission gearing 229 forming the second rotation transmitting unit 210b shown in FIG. 37, there is provided, between the first slide member 242 and the base 241, a gear train 253, which is comprised of plural gears, meshing with one another, and which include a first gear 253a, rotated in unison with the first feed roll 248a, a second gear 253b, rotated in unison with the second feed roll 248b and a counter gear adapted for causing rotation of the first and second gears 253a, 253b in the same direction. Although not shown, another gear train is provided for transmitting the motive power from the driving motor 209 between the gear train 253 on the side of the base 241 and the gear train 230 on the side of the base 220. The first and second feed rolls 248a, 248b may be run in rotation in the same direction by the motive power of the driving motor 209 transmitted via transmission gear 229 to the gear train 253.

The second feed member 223 includes a first feed member 254a and a second feed member 254b, both clamping the outer rim of the optical disc 1, from the opposite sides, at the locations spaced apart from each other along the transport direction for the optical disc 1. The first feed member 254a is a stationary roll, mounted to the distal end of the second rotational member 255. This second rotational member 255 has its proximal end rotatably carried by the second slide member 243 so that the first feed member 254a is movable in a direction towards and away from the second slide member 243. The second feed member 254b is a stationary roll mounted to the second slide member 243.

The second transport unit includes a torsion coil spring 258, as a second biasing member, having its center fixedly mounted to the center of rotation of the second rotational member 255, having its one end retained by a retainer 256 provided to the second slide member 243, and having its other end retained by a retainer 257 provided to the second rotational member 255. The second rotational member 255 is biased by this torsion coil spring 258 in a direction of approaching to the outer rim of the optical disc 1a.

With the present 8 cm disc transporting unit 240, the first feed roll 248a and the first feed member 254a are located towards the disc drive unit 201, while the second feed roll 248b and the second feed member 254b are located towards the stocker 103. When the first feed roll 248a is close to the first feed member 254a, the spacing between the first feed roll 248a and the first feed member 254a is narrower than the spacing between the second feed roll 248b and the second feed member 254b. When the first feed roll 248a is spaced apart from the first feed member 254b, the spacing between the first feed roll 248a and the first feed member 254a is approximately equal to the spacing between the second feed roll 248b and the second feed member 254b.

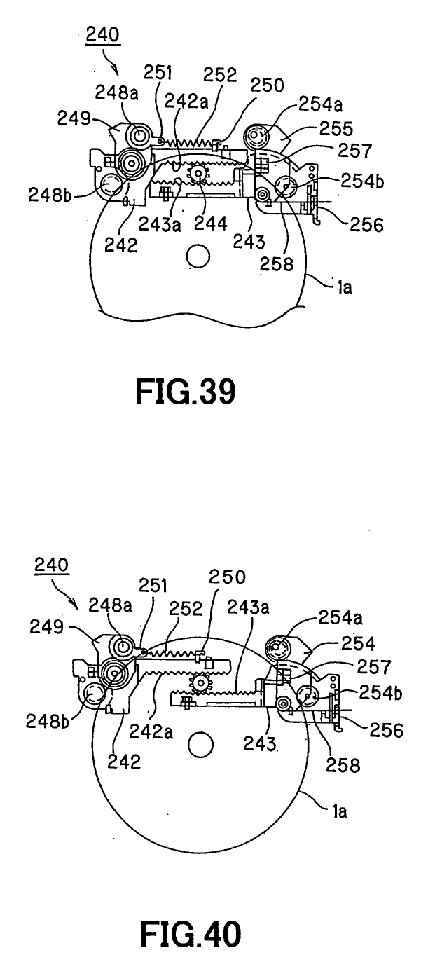

With the above-described 8 cm disc transport unit 240, the selected optical disc 1a may be transported between the disc housing component 102f of the stocker 103 in the housed position and the disc inserting/ejecting opening 203 of the disc drive unit 201 may be transported by causing the rotation of the first feed roll 248a and the second feed roll 248b in the sane direction, as the outer rim of the optical disc 1a is clamped between the first feed roll 248a and the second feed roll 248b on one hand and the first feed member 254a and the second feed member 254b on the other hand, as shown in FIGS. 39 to 43.

Specifically, with the present 8 cm disc transport unit 240, the spacing between the first feed roll 248a and the first feed member 254a when the first feed roll 248a and the first feed member 254a are close to each other is narrower than the spacing between the second feed roll 248b and the second feed member 254b, so that, when the optical disc 1a is transported from the side stocker 103 towards the side disc drive unit 201, the outer rim of the optical disc 1a may be kept in contact with the first feed roll 248a and the first feed member 254a for a longer time. In this manner, the optical disc 1 may be fed more and more towards the side disc drive unit 201, as the first feed roll 248a is kept in rotation.

On the other hand, when the optical disc 1a is transported from the side disc drive unit 201 towards the side stocker 103, rotation is in a direction of spacing the first feed roll 248a apart from the second feed member 254b until the spacing between the first feed roll 248a and the first feed member 254a is approximately equal to the spacing between the second feed roll 248b and the second feed member 254b, so that the transfer of the optical disc 1a from the space between the first feed roll 248a and the first feed member 254a to that between the second feed roll 248b and the second feed member 254b may be carried out more smoothly, as the first feed roll 248a is kept in rotation.

Thus, with the present 8 cm disc transport unit 240, the optical disc 1a may be transported optimally in stability between the stocker 103 and the disc drive unit 201 without contaminating the signal recording surface of the optical disc 1a.

Meanwhile, with the above-described 8 cm disc transport unit 221, the first feed member 254a and the second feed member 254b may be feed rolls rotationally driven in the opposite direction to that of the first feed roll 248a and the second feed roll 248b.

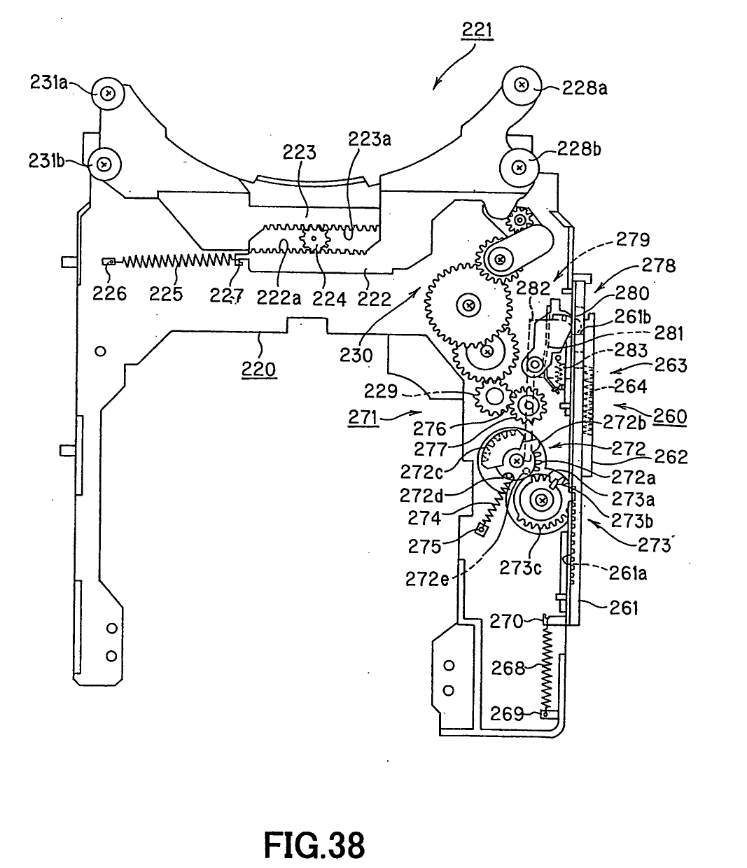

The base 220 is provided with a disc ejection unit 260 for ejecting the optical disc 1 stored in the stocker 103 from the disc insertion/ejection opening 153 of the disc housing component 102 to the transport position by the 12 cm disc transport unit 221 and the 8 cm disc transport unit 240, as shown in FIGS. 33 and 38.

The disc ejection unit 260 includes a slider 261, slidably mounted to a lateral surface of the base 220. This slider is slidable in the direction indicated by arrow A, that is, in the transporting direction for the slider 103 along a lateral side of the main body unit 101. To this slider 261 is mounted a thrusting member 262 for thrusting the operating lever 166a exposed to outside from a lateral surface of each of the disc housing components 102a to 102f via slide levers 181a to 181f of the disc presence/absence detection unit 180.

Between the slider 261 and the thrusting member 262, there is provided a buffer unit 263 for absorbing the difference in the displacement between the slider 261 and the thrusting member 262 produced by application of an external force from the front side to the back side of the main body unit 101, in order to prevent the damage to the disc ejection unit 260 and the stocker 103 when the slider 261 has slid in the opposite direction, that is, from the back side to the front side of the main body unit 101, by a motion transmission unit 271, which will be explained subsequently. This buffer unit 263 includes a compression coil spring 264, as a buffer member. The compression coil spring 264 is maintained in a hold opening 265 in a state of compression between a lug 266 protuberantly formed on the front side end of the hold opening 265 formed in turn in the thrusting member 262, and another lug 267 protuberantly formed on the lateral side of the slider 261 to face the back side end of the hold opening 265.

The disc ejection unit 260 includes a tension coil spring 268, operating as a biasing member for biasing the slider 261 towards the back surface of the main body unit 101. This tension coil spring 268 has its one end retained by a retainer 269 provided to the main body unit 101, while having its other end retained by a retainer 270 provided to the slider 261, for biasing the slider 261 towards the back side of the main body unit 101.

The base 220 is provided with a motive power transmitting unit 271 for transmitting the motive power from the driving motor 209 of the disc drive unit 201 through a transmission gear 229 forming second rotation transmitting unit 210b shown in FIG. 37 to the disc ejection unit 260, as shown in FIG. 38.

Specifically, the motive power transmitting unit 271 includes a first gear member 272, having a first gear 272a, and a second gear member 273, having a second gear 273a. The first and second gears 272a, 273a carry partial teeth at a preset pitch. The first and second gear members 272, 273 are rotationally mounted on the base 220 so that the first and second gears 272a, 273a mesh with each other.

The first gear member 272 includes, apart from the first gear 272a, a thrusting lug 272b and a third gear 272c having partial teeth formed at a preset pitch, and is unidirectionally biased by a tension coil spring 274 operating as a biasing member. The tension coil spring 274 has one end formed by a retention part 272d, provided to the first gear member 272, while having its other end retained by a retention part 275 provided to the base 220.

The second gear member 273 includes, apart from the second gear 273a, a thrust lug 273b and a fourth gear 273c, having partial teeth formed at a preset pitch. The fourth gear 273c meshes with a rack gear 261a formed on the inner lateral surface of the slider 261.

The motive power transmitting unit 271 includes a coupling gear 276 and a rotational arm 277. The coupling gear 276 meshes with the transmission gearing 229 to transmit the motive power from the transmission gearing 229 to the third gear 272c. The rotational arm 277 carries the coupling gear 276 rotationally at the distal end thereof and has its proximal end rotatably mounted to the base 220. The coupling gear 276 is a so-called clutch gear and is able to rotate about the transmission gearing 229, by rotation of the transmission gearing 229, as the coupling gear 276 meshes with the transmission gearing 229. The rotational arm 277 is a switching member for switching between the meshing with the coupling gear 276 and the meshing with the third gear 272c. A support shaft, provided to the center of rotation of the rotational arm, is passed through shaft opening of the transmission gearing 229, to permit rotation in unison with the coupling gear 276.

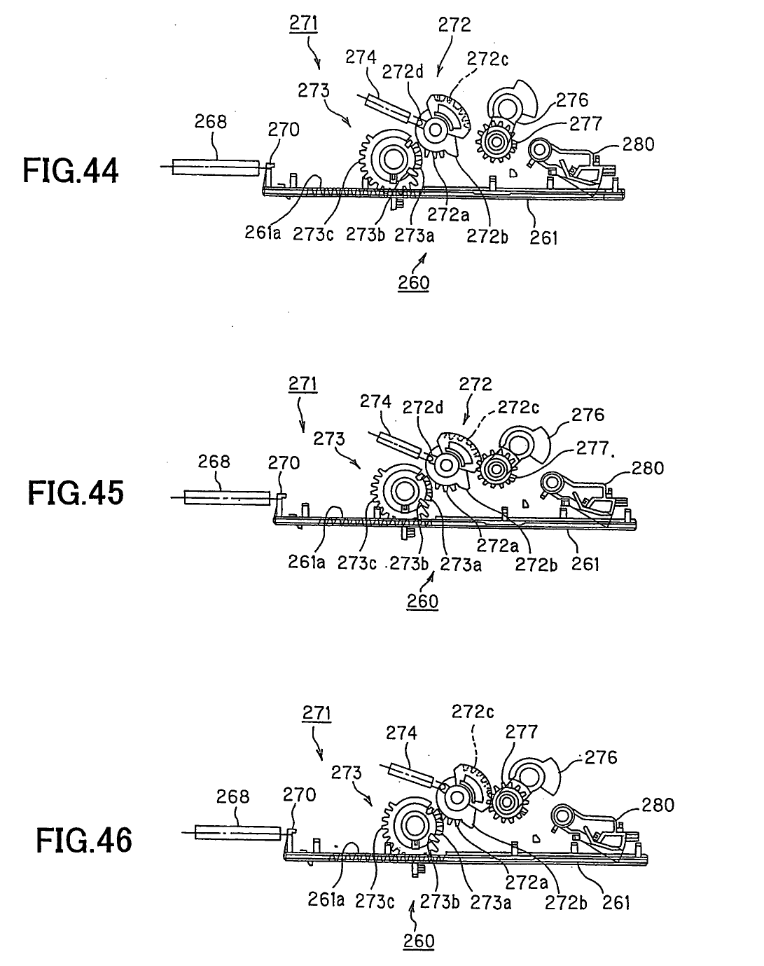

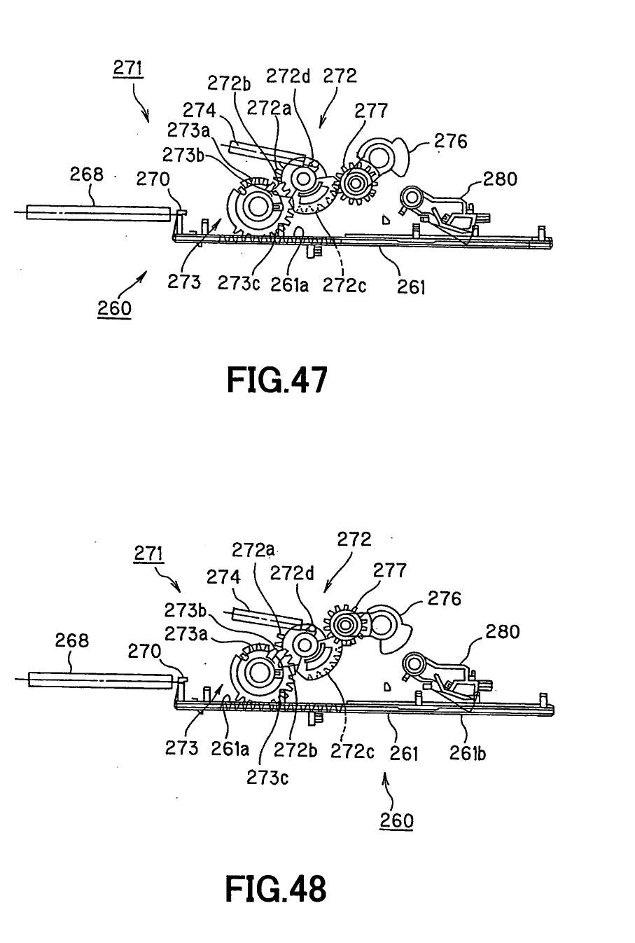

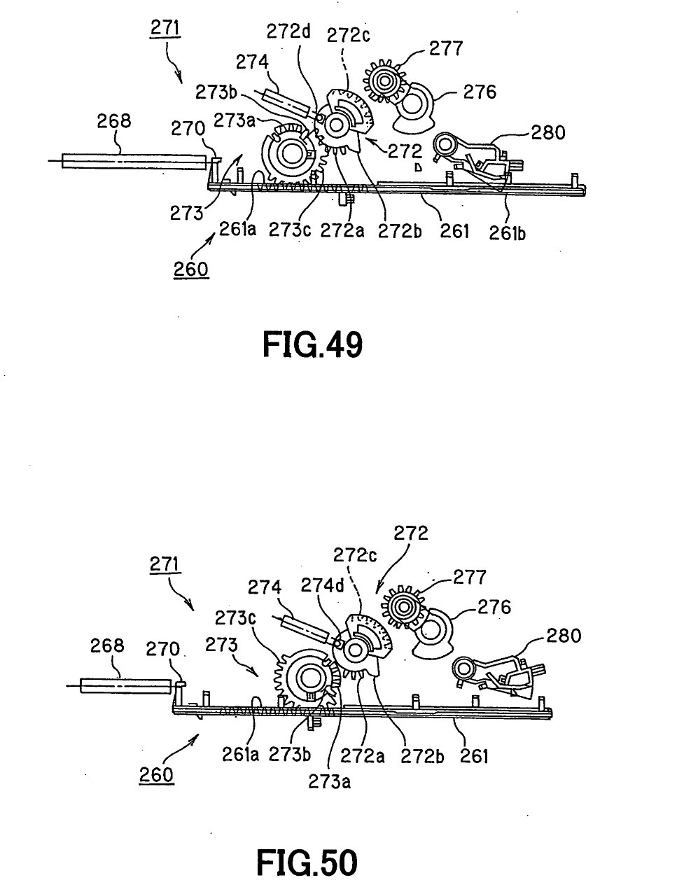

Thus, the coupling gear 276, meshing with the transmission gearing 229, is movable between a first release position in which the coupling gear is freed from meshing with the beginning part of the third gear 272c, shown in FIG. 44, a meshing position meshing with the third gear 272c, shown in FIGS. 45 to 48, and a second release position in which the coupling gear is freed from meshing with the trailing part of the third gear 272c, shown in FIGS. 49 and 50.

The base 220 includes a slide lock unit 278 for retaining the slider 261, slid towards the main body unit 101, against the bias of the tension coil spring 268, and an unlock unit 279 for releasing the locked state by the slide lock unit.

A slide lock unit 278 includes a lock member 280, rotationally mounted on the base 220, and a torsion coil spring 281 for biasing the lock member 280 towards the lock side, and a retention hole 261b, retained by the lock member 280, biased by a torsion coil spring 281 at the lock position, is formed in the slider 261.

The unlock unit 279 includes an unlock pin 272e, protruded from the back side of the first gear member 272, an unlock member 282, thrust by the unlock pin 272e so as to be slid towards the rear side of the main body unit 101, and a tension coil spring 283 for biasing the unlock member 282 towards the back side of the main body unit 101. When the unlock member 282 is slid towards the main body unit 101, the unlock unit 279 disengages the lock member 280 from the retention hole 261b against the bias of the torsion coil spring 281.

With the above-described disc ejection unit 260, the transmission gearing 229, not shown, is rotated in one direction, as shown in FIG. 44, whereby the rotational arm 277 is rotated from the first release position to the meshing position, as the coupling gear 276 of the motive power transmitting unit 271 is kept in rotation.

Then, the first gear member 272 is rotated in one direction, against the bias of the tension coil spring 274, as the coupling gear 276 meshes with the third gear 272c of the first gear member 272, as shown in FIG. 45.

The first gear 272a of the first gear member 272 meshes with the second gear 273a of the second gear member 273, whereby the second gear member 273 is rotated in the direction opposite to the direction of rotation of the first gear member 272, as shown in FIG. 46. At this time, the slider 261 commences to be slid towards the front side of the main body unit 101, against the bias of the tension coil spring 268, by the fourth gear 273c of the second gear member 273 meshing with the rack gear 261a of the slider 261.

Then, directly after the release of the meshing of the first gear 272a with the second gear 273a, the thrusting lug 272b of the first gear member 273 is abutted against the thrust lug 273b of the second gear member 273, as shown in FIG. 46. After the release of the meshing of the first gear 272a with the second gear 273a, the thrusting lug 272b thrusts the thrust lug 273b, whereby the second gear member 272 is rotated with a pitch different from the pitch-to-pitch distance of the first gear 272a and the second gear 273a.

In this manner, the slider 261 may be slid a proper stroke, so that the lock member 280, biased by the torsion coil spring 281 in the lock position, may be reliably engaged in the retention hole 261b of the slider 261, as shown in FIG. 48.

With the lock member 280 engaging in the retention hole 261b, the slider 261 is retained in the lock position on the front surface side of the main body unit 101. At this time, the disc ejection unit 260 transfers from the state shown in FIG. 34 to that shown in FIG. 35, so that the thrusting member 262 of the slider 261, slid to the front surface side of the main body unit 101, thrusts the operating lever 166a, facing to outside via a lateral surface of the disc housing component 102, via slider lever 181. Hence, the abutment roll 167b of the extruding member 167 extrudes the optical disc 1, housed in the disc housing component 102, as the abutment roll is rotated in the direction of ejecting the optical disc 1.

Thus, in the present disc ejection unit 260, the optical disc 1, housed in the stocker 103, may be ejected from the disc insertion/ejection opening 153 of the disc housing component 102, up to the position of transport by the 12 cm disc transport unit 221 and the 8 cm disc transport unit 240.

The uppermost disc housing component 102 is designed so that the thrusting lever 181, thrust by the thrusting member 262, thrusts the operating lever 166a, facing to outside via a lateral surface of the disc housing component 102f via rotational lever 284 mounted for rotation to the base 241 as shown in FIG. 10.

When the rotational arm 277 is rotated from the meshing position towards the second release position, as the coupling gear 276 of the motive power transmitting unit 271 is rotated, the first gear 272a of the first gear member 272 is disengaged from the second gear 273a of the second gear member 273, whereby the first gear member 272, biased by the tension coil spring 274, is rotated in the other direction. This restores the first gear member 272 to the original position.

On the other hand, when the transmission gearing 229, not shown, is rotated from the above state in the other direction, the coupling gear 276 of the motive power transmitting unit 271 is rotated, at the same time that the rotational arm 277 is rotated from the second release position towards the meshing position, as shown in FIG. 50. When the first gear member 272 is rotated in the other direction, against the bias of the tension coil spring 274, with the coupling gear 276 then meshing with the third gear 272c of the first gear member 272, the unlock member 282 is thrust by the unlock pin 272e of the first gear member 272, and is thereby slid towards the front side of the main body unit 101. The lock member 280 is disengaged from an engagement hole 261b, against the bias of the tension coil spring 283. In this manner, the slider 261 is slid towards the back side of the main body unit 101, under the bias of the tension coil spring 268, while the second gear member 272 is returned to the original position by the rack gear 261a of the slider 261 meshing with the fourth gear 273c of the second gear member 273. When the rotational arm 277 is rotated from the meshing position to the first release position, with the coupling gear 276 of the motive power transmitting unit 271 being then kept in rotation, the first gear 272a of the first gear member 272 is disengaged from the second gear 273a of the second gear member 273. Hence, the second gear member 272, biased by the tension coil spring 274, is rotated in the other direction, so that the first gear member 272 is returned to the original position.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A recording medium transporting apparatus comprising
a main body unit;
a stocker for housing a plurality of recording mediums therein; and
a stocker transporting mechanism for rotationally supporting the stocker such that the stocker can be transported across an inner part and an outer side of the main body unit.

2. A recording medium transporting apparatus comprising:
a main body unit;
a stocker having a plurality of disc housing components, each for housing a recording medium, wherein the disc housing components are stacked together; and
a stocker transporting mechanism for transporting the stocker across an inner part and an outer side of the main body unit in a direction parallel to each major surface of the recording medium.

3. The recording medium transporting apparatus according to claim 2 wherein the stocker is supported by the stocker transporting mechanism.

4. The recording medium transporting apparatus according to claim 2 wherein the stocker transporting mechanism transports the stocker in entirety thereof to outside the apparatus.

5. The recording medium transporting apparatus according to claim 2 wherein, when the stocker has been transported to outside the main body unit, the stocker transporting mechanism rotates the stocker so that the major surfaces of the recording mediums are oriented in a direction different from a direction of the major surfaces of the recording mediums in which the major surfaces are oriented during transport of the stocker within the main body unit.

6. The recording medium transporting apparatus according to claim 5 wherein, when the stocker has been transported to outside the main body unit, the stocker transporting mechanism rotates the stocker so that the major surfaces of the recording mediums housed in the stocker are oriented in a direction perpendicular to the direction of the major surfaces of the recording mediums in which the major surfaces are oriented during transport of the stocker within the main body unit.

7. The recording medium transporting apparatus according to claim 2 wherein, when the stocker has been transported to outside the main body unit, the stocker transporting mechanism offsets the recording mediums in a direction substantially perpendicular to the stacking direction.

8. A disc changer apparatus comprising
a stocker including a plurality of disc housing components for housing a plurality of disc-shaped recording mediums in a stacked state;
a main body unit including a disc drive unit for recording and/or reproducing signals for a selected one of the disc-shaped recording mediums housed in the stocker; and
a stocker transporting mechanism for transporting the stocker between a pullout position in which the stocker is pulled out from the main body unit and a housed position in which the stocker is pulled into and housed within the main body unit, wherein
when the stocker has been transported to the pullout position, the stocker transporting mechanism rotates the stocker so that a disc insertion/ejection opening of the disc housing component is oriented in a direction different from a direction when the stocker is in the housing position.

9. The disc changer apparatus according to claim 8 wherein
when the stocker has been transported to the pullout position, the stocker transporting mechanism sequentially offsets the disc housing components in unison with rotation of the stocker along a direction of insertion/ejection of the disc-shaped recording mediums.

10. The disc changer apparatus according to claim 8 wherein
when the stocker has been transported to the housed position, the stocker transporting mechanism rotates the stocker in one direction so that the disc insertion/ejection opening of each disc housing component is oriented in a direction towards an inside of the main body unit, and wherein
when the stocker has been transported to the pullout position, the stocker transporting mechanism rotates the stocker in another direction so that the disc insertion/ejection opening of each disc housing component is oriented upwards.

11. The disc changer apparatus according to claim 10 wherein the stocker transporting mechanism includes a rotation lock mechanism for halting the stocker rotation when the stocker is in the pullout position.

12. The disc changer apparatus according to claim 10 wherein the stocker transporting mechanism includes a thrusting mechanism for thrusting the stocker rotated up to an end in the one direction and towards the one direction, when the stocker is in the pullout position.

13. The disc changer apparatus according to claim 8 wherein the stocker transporting mechanism commences operation of transporting the stocker from the pullout position to the housed position by pulling or pushing the stocker when the stocker is in the pullout position.

14. The disc changer apparatus according to claim 8 further comprising
a disc presence/absence detection mechanism for detecting a presence/absence of a disc-shaped recording medium in each disc housing component when the stocker has been transported from the pullout position to the housed position.

15. The disc changer apparatus according to claim 8 wherein
the stocker includes a disc housing component dedicated to a small-sized disc, the dedicated disc housing component housing a disc-shaped recording medium smaller in diameter than the disc-shaped recording mediums housed in other disc housing components.

16. The disc changer apparatus according to claim 15 wherein
the dedicated disc housing component is arranged in an uppermost layer of the stacked disc housing components.

17. The disc changer apparatus according to claim 8 further comprising
a disc transporting mechanism for transporting the selected disc-shaped recording medium between the stocker in the housed position and the disc drive unit;
a base having loaded thereon the disc transporting mechanism and the disc drive unit; and
a base uplifting/lowering mechanism for uplifting/lowering the base.

18. The disc changer apparatus according to claim 17 wherein
the disc driving unit is arranged on the base with a disc inlet/outlet that faces the stocker in a slightly upturned state.
